(19) United States
(12) Patent Application Publication
(10) Pub. No.: US 2014/0151606 A1
(43) Pub. Date: Jun. 5, 2014

(54) Ultraviolet-Curable Conductive Ink and Dielectric Ink Compositions Having a Common Binding Medium, with Manufactures and Fabrication Methods

(71) Applicant: NthDegree Technologies Worldwide Inc., Tempe, AZ (US)

(72) Inventors: Mark David Lowenthal, Gilbert, AZ (US); Mark Lewandowski, North Port, FL (US); Alexandra Elyse Hartman, Tolleson, AZ (US)

(21) Appl. No.: 14/086,821

(22) Filed: Nov. 21, 2013

Related U.S. Application Data
(60) Provisional application No. 61/732,125, filed on Nov. 30, 2012.

(51) Int. Cl. C09D 11/00

(52) U.S. Cl. CPC C09D 11/52
USPC 252/503

(57) ABSTRACT

Compositions, methods and manufactures are disclosed for an ultraviolet-curable conductive ink and for a binding medium which may be utilized for both a dielectric ink and for a conductive ink. A representative ultraviolet-curable binding medium composition comprises: a difunctional aliphatic polycarbonate urethane acrylate oligomer; a monofunctional monomer such as an isophoryl acrylate monomer or an acrylate ester monomer; a difunctional monomer such as a difunctional alkoxylated acrylate or methacrylate monomer; a first photoinitiator such as an α-hydroxyketone class photoinitiator; and a second photoiniator such as an α-aminoketone class photoinitiator. A plurality of conductive particles, such as silver particles and graphene particles, may be included in the binding medium to provide an ultraviolet-curable conductive ink and, when cured, a conductive layer or wire, for example.

### CROSS-REFERENCE TO A RELATED APPLICATION

This application is a nonprovisional and conversion of and, under 35 U.S.C. Section 119, claims the benefit of and priority to U.S. Provisional Patent Application No. 61/732,125, filed Nov. 30, 2012, inventors Mark D. Lowenthal et al., entitled “Dielectric Ink Composition, Insulating Films and Manufactures, and Fabrication Methods”, which is commonly assigned herewith, the entire contents of which are incorporated herein by reference with the same full force and effect as if set forth in its entirety herein, and with priority claimed for all commonly disclosed subject matter.

### FIELD OF THE INVENTION

The present invention in general is related to both conductive inks and to dielectric or insulating inks and polymers, utilized to manufacture various electrical and electronic apparatus, and in particular, is related to conductive ink and dielectric ink compositions capable of being printed, resulting articles of manufacture, and methods of manufacturing conductive ink and dielectric ink compositions.

### BACKGROUND

There are many high transparency conductive and insulating inks which are curable under ultraviolet (uv) radiation. Generally, such uv-curable inks, however, are not appropriate for use in functional electronic devices constructed entirely using printing technology. The few that are design for this type of application either do not have the optical clarity needed for fully printed optoelectronic devices or can only be overcoated or overprinted with another UV-curable ink, and not a heat-curable ink.

In addition, many such inks are effectively incompatible with one another, with the various printed layers insufficiently adhering to one another, resulting in an unstable electrical or electronic device. For example, an insulating (or dielectric) ink which is printed over a conductive ink may leave gaps or subsequently shear or peel away, resulting in inadequate insulation in the resulting electrical, electronic or optoelectronic device.

Accordingly, a need remains for a common ink binder or binding medium which may be utilized in both a conductive ink and a dielectric (or insulating) ink, providing a conductive ink and dielectric ink system. A need remains for a uv-curable, highly conductive ink which may be readily overcoated or overprinted with a compatible uv-curable dielectric ink, and vice-versa, to produce a highly resilient electrical, electronic or optoelectronic device. Such a conductive ink should be capable of producing a resulting highly conductive layer or wire which has comparatively low impedance or resistivity, including at comparatively small feature sizes, and further should be highly flexible and durable. In addition, a need remains for a dielectric ink which is uv-curable, and which may be overcoated or overprinted with another composition which is either uv-curable or heat curable. Such a dielectric ink should be capable of producing a resulting insulating layer or article of manufacture which exhibits significant optical transparency and comparatively low surface roughness.

### SUMMARY

A common binding medium or ink binder is disclosed which may be utilized directly as a dielectric (or insulating) ink and further, with the addition into this common binding medium composition of conductive particles, flakes, wires or threads, utilized as a conductive ink. Such an exemplary or representative uv-curable, highly conductive ink may be readily overcoated or overprinted with a compatible uv-curable dielectric ink, and vice-versa, to produce a highly resilient electrical, electronic or optoelectronic device. Such an exemplary or representative conductive ink is capable of producing a resulting highly conductive layer or wire which has comparatively low impedance or resistivity, including at comparatively small feature sizes, and further is both highly flexible and durable. Impedance measurements for conductive layers and wires produced by exemplary or representative conductive inks of the present disclosure have been as low as 30 milliohms per square (mΩ/□) (as normalized per mil of thickness), approximately two to three times lower than the best conductive inks currently available in the commercial marketplace.

In addition, an exemplary or representative common binding medium (or ink binder) further provides a dielectric ink which is uv-curable, and which may be overcoated or overprinted with another composition which is either uv-curable or heat curable, including the conductive ink of the present disclosure. Such an exemplary or representative dielectric ink is also capable of producing a resulting insulating layer or article of manufacture which exhibits significant optical transparency and comparatively low surface roughness, in addition to providing significant electrical insulation.

An exemplary or representative composition, for an ultraviolet-curable conductive ink, comprises: a plurality of conductive particles; a difunctional aliphatic polycarbonate urethane acrylate oligomer; a monofunctional acrylate monomer selected from the group consisting of: an isophoryl acrylate monomer, an acrylate ester monomer, a 3,3,5 trimethyl cyclohexanol acrylate monomer, and mixtures thereof; a difunctional acrylate monomer selected from the group consisting of: a difunctional alkoxylated acrylate monomer, a difunctional methacrylate monomer, an alkoxylated hexandiol acrylate monomer, a 1,6-hexandiol diacrylate monomer, and mixtures thereof; a first photoinitiator comprising an α-hydroxyketone class photoinitiator; a second photoiniator different from the first photoinitiator and comprising an α-aminoketone class photoinitiator; and a wetting, flow and/or leveling promoter comprising one or more copolymers of ethyl acrylate and 2-ethylhexyl acrylate.

In a representative conductive ink composition embodiment, the plurality of conductive particles comprise at least one conductor selected from the group consisting of: aluminum, copper, silver, gold, nickel, palladium, tin, platinum, lead, zinc, graphene, alloys thereof, and mixtures thereof. For example, the plurality of conductive particles may comprise a mixture of graphene particles, and either or both silver particles or silver coated copper particles.

In a representative conductive ink composition embodiment, the plurality of conductive particles are present in an amount between about 77.5% to 82.5% by weight and comprise silver particles and graphene particles; the difunctional aliphatic polycarbonate urethane acrylate oligomer is present in an amount between about 9.5% to 10.5% by weight; the monofunctional acrylate monomer is present in an amount between about 5.5% to 6.5% by weight; the difunctional acrylate monomer is present in an amount between about 0.6% to 1.2% by weight; the first photoinitiator is present in an amount between about 1.8% to 2.2% by weight; the second photoiniator is present in an amount between about 0.8% to 1.2% by weight; and the wetting, flow and/or leveling promoter is present in an amount between about 0.14% to 0.3% by weight. The graphene particles may be present in an amount between about 0.20% to 0.30% by weight. In a representative embodiment, the graphene particles are present in an amount of about 0.25% by weight and the silver particles are present in an amount of about 79.75% by weight.

An exemplary or representative method of manufacturing the conductive ink composition is also disclosed, comprising: mixing the first and second photoinitiators with the monofunctional acrylate monomer to form a photoinitiator monofunctional acrylate monomer mixture; mixing the difunctional aliphatic polycarbonate urethane acrylate oligomer and the monofunctional acrylate monomer to form an oligomer and monomer mixture; mixing the photoinitiator monofunctional acrylate monomer mixture with the oligomer and monomer mixture; adjusting any weight percentages of the monofunctional acrylate monomer and difunctional aliphatic polycarbonate urethane acrylate oligomer; adding and mixing the difunctional acrylate monomer and the wetting, flow and/or leveling promoter or promotion agent; adding and mixing the silver particles; and adding and mixing the graphene particles.

In a representative embodiment, a conductive layer, film or trace may be formed from ultraviolet and thermal curing of the conductive ink composition.

Another exemplary or representative composition, for an ultraviolet-curable conductive ink, comprises: a plurality of conductive particles; a difunctional aliphatic polycarbonate urethane acrylate oligomer; a monofunctional monomer selected from the group consisting of: urethane monomers, acrylate monomers, epoxy monomers, vinyl monomers, vinyl-ether monomers, polyester monomers, and mixtures thereof; a difunctional or trifunctional monomer selected from the group consisting of: urethane monomers, acrylate monomers, epoxy monomers, vinyl monomers, vinyl-ether monomers, polyester monomers, and mixtures thereof; a first photoinitiator; and a second photoiniator different from the first photoinitiator.

In a representative conductive ink composition embodiment, the monofunctional monomer may be a monofunctional acrylate monomer. For example, the monofunctional monomer may be selected from the group consisting of: an isophoryl acrylate monomer, an acrylate ester monomer, a 3,3,5 trimethyl cyclohexanol acrylate monomer, vinyl pyrollidone, vinyl caprolactam, and mixtures thereof. In a representative embodiment, the difunctional or trifunctional monomer may be a difunctional acrylate monomer. For example, the difunctional or trifunctional monomer may be selected from the group consisting of: a difunctional alkoxylated acrylate monomer, a difunctional methacrylate monomer, an alkoxylated hexandiol acrylate monomer, a 1,6-hexandiol diacrylate monomer, and mixtures thereof.

An exemplary or representative conductive ink composition may also include a wetting, flow and/or leveling promoter or promotion agent, such as an acrylate copolymer. For example, the wetting, flow and/or leveling promoter or promotion agent may be one or more copolymers of ethyl acrylate and 2-ethylhexyl acrylate.

Various representative embodiments may further comprise a thermal initiator. In a representative embodiment, the first photoinitiator, the second photoiniator and the thermal initiator are selected from the group consisting of: 1,1-bis(tert-butylperoxy)-3,3,5-trimethylcyclohexane, 1,1′-azobis(cyclohexanecarbonitrile), benzoyl peroxide, tert-butyl peroxy-2 ethylhexanoate, 1,1-Di(tert-butylperoxy)-3,3,5-trimethylcyclohexane, α-hydroxyketones, phenylglyoxylates, benzyldimethyl-ketals, α-aminoketones, mono acyl phosphines, bis acyl phosphines, phosphine oxides, metallocenes, iodonium salts, and mixtures thereof. For example, the first photoinitiator may be an α-hydroxyketone class photoinitiator and the second photoinitiator may be an α-aminoketone class photoinitiator.

Another exemplary or representative composition, for an ultraviolet-curable conductive ink, comprises: a plurality of conductive particles present in an amount between about 77.5% to 82.5% by weight and comprising silver particles and graphene particles; a difunctional aliphatic polycarbonate urethane acrylate oligomer present in an amount between about 9.5% to 10.5% by weight; a monofunctional acrylate monomer present in an amount between about 5.5% to 6.5% by weight and selected from the group consisting of: an isophoryl acrylate monomer, an acrylate ester monomer, a 3,3,5 trimethyl cyclohexanol acrylate monomer, and mixtures thereof; a difunctional acrylate monomer present in an amount between about 0.6% to 1.2% by weight and selected from the group consisting of: a difunctional alkoxylated acrylate monomer, a difunctional methacrylate monomer, an alkoxylated hexandiol acrylate monomer, a 1,6-hexandiol diacrylate monomer, and mixtures thereof; a first photoinitiator present in an amount between about 1.8% to 2.2% by weight and comprising an α-hydroxyketone class photoinitiator; a second photoiniator different from the first photoinitiator, the second photoiniator present in an amount between about 0.8% to 1.2% by weight and comprising an α-aminoketone class photoinitiator; and one or more copolymers of ethyl acrylate and 2-ethylhexyl acrylate present in an amount between about 0.14% to 0.3% by weight.

Various representative conductive ink composition embodiments, and also binding medium embodiments, may further comprise at least one solvent selected from the group consisting of: water; alcohols; cyclic alcohols; lactones; cyclic ketones; glycols; glycerols; carboxylic acids; dicarboxylic acids; tricarboxylic acids; alkyl carboxylic acids; benzene derivatives; butane derivatives; and mixtures thereof. Various representative embodiments may further comprise a viscosity or rheology modifier selected from the group consisting of: acrylate and (meth)acrylate polymers, copolymers, polymeric precursors or polymerizable precurors; fumed silica, silica powders; and mixtures thereof.

Another exemplary or representative composition disclosed is for an ultraviolet-curable binding medium which may be utilized for a dielectric ink and for a conductive ink, with the composition comprising: a difunctional aliphatic polycarbonate urethane acrylate oligomer; a monofunctional acrylate monomer selected from the group consisting of: an isophoryl acrylate monomer, an acrylate ester monomer, a 3,3,5 trimethyl cyclohexanol acrylate monomer, and mixtures thereof; a difunctional acrylate monomer selected from the group consisting of: a difunctional alkoxylated acrylate monomer, a difunctional methacrylate monomer, an alkoxylated hexandiol acrylate monomer, a 1,6-hexandiol diacrylate monomer, and mixtures thereof; a first photoinitiator comprising an α-hydroxyketone class photoinitiator; a second photoiniator different from the first photoinitiator and comprising an α-aminoketone class photoinitiator; and a wetting, flow and/or leveling promoter comprising one or more copolymers of ethyl acrylate and 2-ethylhexyl acrylate.

In a representative embodiment, the difunctional aliphatic polycarbonate urethane acrylate oligomer is present in an amount between about 47.5% to 52.5% by weight; the monofunctional acrylate monomer is present in an amount between about 27.5% to 32.5% by weight; the difunctional acrylate monomer is present in an amount between about 3.0% to 6.0% by weight; the first photoinitiator is present in an amount between about 9.0% to 11.0% by weight; the second photoiniator is present in an amount between about 4.0% to 6.0% by weight; and the wetting, flow and/or leveling promoter is present in an amount between about 0.7% to 1.5% by weight.

In a representative embodiment, an insulating layer, film or trace may be formed from ultraviolet and thermal curing of the binding medium composition.

In another representative embodiment, the inclusion of conductive particles in the binding medium will form a conductive ink composition. For example, an exemplary or representative binding medium may further comprise a plurality of conductive particles, such as comprising a mixture of graphene particles and either or both silver particles or silver coated copper particles, to form a conductive ink composition of the present disclosure.

Another exemplary or representative composition for an ultraviolet-curable binding medium, which may be utilized for a dielectric ink and for a conductive ink, comprises: a difunctional oligomer comprising a difunctional aliphatic polycarbonate urethane acrylate oligomer; a monofunctional monomer selected from the group consisting of: urethane monomers, acrylate monomers, epoxy monomers, vinyl monomers, vinyl-ether monomers, polyester monomers, and mixtures thereof; a difunctional or trifunctional monomer selected from the group consisting of: urethane monomers, acrylate monomers, epoxy monomers, vinyl monomers, vinyl-ether monomers, polyester monomers, and mixtures thereof; a first photoinitiator; and a second photoiniator different from the first photoinitiator.

For example, the monofunctional monomer may be a monofunctional acrylate monomer. Also for example, the monofunctional monomer may be selected from the group consisting of: an isophoryl acrylate monomer, an acrylate ester monomer, a 3,3,5 trimethyl cyclohexanol acrylate monomer, vinyl pyrollidone, vinyl caprolactam, and mixtures thereof.

Also for example, the difunctional monomer may be a difunctional acrylate monomer. For example, the difunctional or trifunctional monomer may be selected from the group consisting of: a difunctional alkoxylated acrylate monomer, a difunctional methacrylate monomer, an alkoxylated hexandiol acrylate monomer, a 1,6-hexandiol diacrylate monomer, and mixtures thereof.

An exemplary binding medium composition may further comprise a wetting, flow and/or leveling promoter or promotion agent comprising an acrylate copolymer, such as one or more copolymers of ethyl acrylate and 2-ethylhexyl acrylate. An exemplary binding medium composition may further comprise a thermal initiator, as discussed above.

In a representative binding medium embodiment, the difunctional aliphatic polycarbonate urethane acrylate oligomer is present in an amount between about 47.5% to 52.5% by weight; the monofunctional monomer is present in an amount between about 27.5% to 32.5% by weight and comprises a monofunctional acrylate monomer selected from the group consisting of: an isophoryl acrylate monomer, an acrylate ester monomer, a 3,3,5 trimethyl cyclohexanol acrylate monomer, and mixtures thereof; the difunctional or trifunctional monomer is present in an amount between about 3.0% to 6.0% by weight and comprises a difunctional acrylate monomer selected from the group consisting of: a difunctional alkoxylated acrylate monomer, a difunctional methacrylate monomer, an alkoxylated hexandiol acrylate monomer, a 1,6-hexandiol diacrylate monomer, and mixtures thereof; the first photoinitiator is present in an amount between about 9.0% to 11.0% by weight and comprises an α-hydroxyketone class photoinitiator; and the second photoiniator is present in an amount between about 4.0% to 6.0% by weight and comprises an α-aminoketone class photoinitiator. In a representative embodiment, a plurality of conductive particles may be includes to form a conductive ink, wherein the plurality of conductive particles comprise at least one conductor selected from the group consisting of: aluminum, copper, silver, gold, nickel, palladium, tin, platinum, lead, zinc, graphene, alloys thereof, and mixtures thereof.

Another exemplary or representative composition for an ultraviolet-curable binding medium, which may be utilized for a dielectric ink and for a conductive ink, comprises: a difunctional aliphatic polycarbonate urethane acrylate oligomer present in an amount between about 47.5% to 52.5% by weight; a monofunctional acrylate monomer present in an amount between about 27.5% to 32.5% by weight and selected from the group consisting of: an isophoryl acrylate monomer, an acrylate ester monomer, a 3,3,5 trimethyl cyclohexanol acrylate monomer, and mixtures thereof; a difunctional acrylate monomer present in an amount between about 3.0% to 6.0% by weight and selected from the group consisting of: a difunctional alkoxylated acrylate monomer, a difunctional methacrylate monomer, an alkoxylated hexandiol acrylate monomer, a 1,6-hexandiol diacrylate monomer, and mixtures thereof; a first photoinitiator present in an amount between about 9.0% to 11.0% by weight and comprising an α-hydroxyketone class photoinitiator; a second photoiniator different from the first photoinitiator, the second photoiniator present in an amount between about 4.0% to 6.0% by weight and comprising an α-aminoketone class photoinitiator; and one or more copolymers of ethyl acrylate and 2-ethylhexyl acrylate present in an amount between about 0.7% to 1.5% by weight.

Another representative composition for an ultraviolet-curable conductive ink comprises: a plurality of conductive particles; a difunctional or trifunctional oligomer selected from the group consisting of: urethane oligomers, acrylate oligomers, epoxy oligomers, vinyl oligomers, vinyl-ether oligomers, polyester oligomers, and mixtures thereof; a monofunctional monomer selected from the group consisting of: urethane monomers, acrylate monomers, epoxy monomers, vinyl monomers, vinyl-ether monomers, polyester monomers, and mixtures thereof; a difunctional monomer selected from the group consisting of: urethane monomers, acrylate monomers, epoxy monomers, vinyl monomers, vinyl-ether monomers, polyester monomers, and mixtures thereof; a first photoinitiator; and a second photoiniator different from the first photoinitiator.

Another representative composition for an ultraviolet-curable binding medium, which may be utilized for a dielectric ink and for a conductive ink, comprises: a difunctional or trifunctional oligomer selected from the group consisting of: urethane oligomers, acrylate oligomers, epoxy oligomers, vinyl oligomers, vinyl-ether oligomers, polyester oligomers, and mixtures thereof; a monofunctional monomer selected from the group consisting of: urethane monomers, acrylate monomers, epoxy monomers, vinyl monomers, vinyl-ether monomers, polyester monomers, and mixtures thereof; a difunctional monomer selected from the group consisting of: urethane monomers, acrylate monomers, epoxy monomers, vinyl monomers, vinyl-ether monomers, polyester monomers, and mixtures thereof; a first photoinitiator; and

a second photoiniator different from the first photoinitiator.

Numerous other advantages and features of the present invention will become readily apparent from the following detailed description of the invention and the embodiments thereof, from the claims and from the accompanying drawings.

### DETAILED DESCRIPTION OF REPRESENTATIVE EMBODIMENTS

While the present invention is susceptible of embodiment in many different forms, there are shown in the drawings and will be described herein in detail specific exemplary embodiments thereof, with the understanding that the present disclosure is to be considered as an exemplification of the principles of the invention and is not intended to limit the invention to the specific embodiments illustrated. In this respect, before explaining at least one embodiment consistent with the present invention in detail, it is to be understood that the invention is not limited in its application to the details of construction and to the arrangements of components set forth above and below, illustrated in the drawings, or as described in the examples. Methods and apparatuses consistent with the present invention are capable of other embodiments and of being practiced and carried out in various ways. Also, it is to be understood that the phraseology and terminology employed herein, as well as the abstract included below, are for the purposes of description and should not be regarded as limiting.

As mentioned above, a common binding medium (or ink binder) is disclosed which may be utilized directly as a dielectric (or insulating) ink and, furthermore, with the addition of conductive particles, flakes, wires or threads, as a conductive ink. Exemplary compositions are described below, including Examples 1-26 below and the various claims.

An exemplary or representative uv-curable, highly conductive ink may be readily overcoated or overprinted with a compatible uv-curable dielectric ink, and vice-versa, to produce a highly resilient electrical, electronic or optoelectronic device. Such an exemplary or representative conductive ink is capable of producing a resulting highly conductive layer or wire which has comparatively low impedance or resistivity, including at comparatively small feature sizes, and further is both highly flexible and durable. Impedance measurements for conductive layers and wires produced by exemplary or representative conductive inks of the present disclosure have been as low as 30 Ohms per square (Ω/□) (as normalized per mil of thickness), approximately two to three times lower than the best conductive inks currently available in the commercial marketplace. Exemplary compositions are described below, including Examples 16-26 below and the various claims.

In addition, an exemplary or representative common ink binder or binding medium further provides a dielectric ink which is uv-curable, and which may be overcoated or overprinted with another composition which is either uv-curable or heat curable. Such an exemplary or representative dielectric ink is also capable of producing a resulting insulating layer or article of manufacture which exhibits significant optical transparency and comparatively low surface roughness, in addition to providing significant electrical insulation. For example and without limitation, the various transparent uv-curable dielectric inks described herein can also be utilized with transparent conductors, such as those described in U.S. Pat. No. 8,454,859. Exemplary compositions are described below, including Examples 1-15 below and the various claims.

Also for example and without limitation, the exemplary or representative conductive ink of the present disclosure, which may be utilized for forming a conductive layer, trace or wire, for example and without limitation, in combination with an exemplary or representative dielectric ink of the present disclosure, which may be utilized for forming an insulating layer (e.g., on or around a conductive layer), also for example and without limitation, forms a highly novel conductive ink and dielectric ink system of the present disclosure. Advantageously, the use of the conductive ink and dielectric ink system provides for comparatively better compatibility between the resulting conductors and insulators. Such resulting conductors and insulators typically will then have the same coefficients of thermal expansion, resulting in improved durability, and similar surface properties, such as wettability, for advantages in manufacturing, also for example and without limitation.

Exemplary embodiments of the invention provide conductive ink and dielectric ink compositions which are capable of being printed. An exemplary method of the invention also comprises a method of manufacturing conductive ink and dielectric ink compositions which, as discussed in greater detail below, are capable of being printed, for example, to produce a conductive wire/layer or substantially transparent insulator, respectively, when cured or solidified, such as for the manufacture of LED-based devices and photovoltaic devices, for example and without limitation. Exemplary conductors, conductive films (or layers), insulators, insulating films (or layers), apparatuses and systems formed by printing such exemplary or representative conductive ink and dielectric ink compositions are also disclosed.

The conductive ink and dielectric ink compositions disclosed herein may be deposited, printed or otherwise applied to any substrate, device, or may be deposited, printed or otherwise applied to any product of any kind or to form any product of any kind, including lighting, photovoltaic panels, electronic displays such as computer, television, tablet and mobile device displays, packaging, signage or indicia for product packaging, or as a conductor for any other product or device, such as a consumer product, a personal product, a business product, an industrial product, an architectural product, a building product, etc. The conductive ink and dielectric ink compositions may be printed onto the substrate, device, article, or packaging thereof, as either a functional or decorative component of the article, package, or both. In one embodiment, the dielectric ink composition is printed to form insulating films and insulating traces, and the conductive ink is printed to form conductive wires and conductive layers such as electrodes, for light emitting diodes or photovoltaic diodes. In another embodiment, the dielectric ink composition is printed to form insulating films and insulating traces, and the conductive ink is printed to form conductive wires and conductive layers such as electrodes, for any two, three or more terminal device, such as a transistor or RFID tag. The article or package may be formed from any consumer-acceptable material.

For example and without limitation, the conductive ink composition disclosed herein may be utilized to form conductive wires and conductive layers, and the dielectric ink composition disclosed herein may be utilized to form any of the insulating (or dielectric) films, layers, and/or traces, transparent or otherwise, for the apparatuses, methods, and systems referred to and disclosed in the following U.S. patent applications and U.S. patents: U.S. patent application Ser. No. 12/753,888; U.S. patent application Ser. No. 12/753,887; U.S. Pat. No. 7,719,187; U.S. Pat. No. 7,972,031; U.S. Pat. No. 7,992,332; U.S. patent application Ser. No. 12/560,334; U.S. patent application Ser. No. 12/560,340; U.S. patent application Ser. No. 12/560,355; U.S. patent application Ser. No. 12/560,364; U.S. patent application Ser. No. 12/560,371; U.S. patent application Ser. No. 13/025,137; and U.S. patent application Ser. No. 13/025,138.

### Binding Medium Example 1

A binding medium composition which may be utilized as a dielectric ink, the composition comprising:
a monofunctional, difunctional or trifunctional urethane, acrylate, epoxy, vinyl, vinyl-ether and/or polyester oligomer;
a monofunctional urethane, acrylate, epoxy, vinyl, vinyl-ether and/or polyester monomer; and
a difunctional or trifunctional monomer (or cross-linking agent).

### Binding Medium Example 2

A binding medium composition which may be utilized as a dielectric ink, the composition comprising:
a difunctional urethane, acrylate, epoxy, vinyl, vinyl-ether and/or polyester oligomer;
a monofunctional urethane, acrylate, epoxy, vinyl, vinyl-ether and/or polyester monomer; and
a difunctional monomer (or cross-linking agent), such as a difunctional urethane, acrylate, epoxy, vinyl, vinyl-ether and/or polyester monomer.

### Binding Medium Example 3

A binding medium composition which may be utilized as a dielectric ink, the composition comprising:
a difunctional urethane, acrylate, epoxy, vinyl, vinyl-ether and/or polyester oligomer;
a monofunctional urethane, acrylate, epoxy, vinyl, vinyl-ether and/or polyester monomer;
a difunctional monomer (or cross-linking agent); and
a photoinitiator and/or a thermal initiator.

### Binding Medium Example 4

A binding medium composition which may be utilized as a dielectric ink, the composition comprising:
a difunctional urethane, acrylate, epoxy, vinyl, vinyl-ether and/or polyester oligomer;
a monofunctional urethane, acrylate, epoxy, vinyl, vinyl-ether and/or polyester monomer;
a difunctional monomer (or cross-linking agent);
a first photoinitiator for a first range of wavelengths; and
a second photoinitiator for a second range of wavelengths.

### Binding Medium Example 5

A binding medium composition which may be utilized as a dielectric ink, the composition comprising:
a difunctional urethane, acrylate, epoxy, vinyl, vinyl-ether and/or polyester oligomer;
a monofunctional urethane, acrylate, epoxy, vinyl, vinyl-ether and/or polyester monomer;
a difunctional urethane, acrylate, epoxy, vinyl, vinyl-ether and/or polyester monomer (or cross-linking agent);
a wetting, flow and/or leveling promoter or promotion agent; and
a photoinitiator and/or a thermal initiator.

### Binding Medium Example 6

A binding medium composition which may be utilized as a dielectric ink, the composition comprising:
a difunctional urethane, acrylate, epoxy, vinyl, vinyl-ether and/or polyester oligomer;
a monofunctional urethane, acrylate, epoxy, vinyl, vinyl-ether and/or polyester monomer;
a difunctional urethane, acrylate, epoxy, vinyl, vinyl-ether and/or polyester monomer (or cross-linking agent);
a wetting, flow and/or leveling promoter or promotion agent;
a photoinitiator; and
a viscosity or rheology modifier.

### Binding Medium Example 7

A binding medium composition which may be utilized as a dielectric ink, the composition comprising:
a difunctional urethane, acrylate, epoxy, vinyl, vinyl-ether and/or polyester oligomer present in an amount between about 20% to 80% by weight;
a monofunctional urethane, acrylate, epoxy, vinyl, vinyl-ether and/or polyester monomer present in an amount between about 10% to 70% by weight;
a difunctional urethane, acrylate, epoxy, vinyl, vinyl-ether and/or polyester monomer (or cross-linking agent) present in an amount between about 1% to 20% by weight;
a wetting, flow and/or leveling promoter or promotion agent present in an amount between about 0.1% to 10% by weight;
a first photoinitiator for a first range of wavelengths and present in an amount between about 1% to 20% by weight; and
a second photoinitiator for a second range of wavelengths and present in an amount between about 1% to 20% by weight.

### Binding Medium Example 8

A binding medium composition which may be utilized as a dielectric ink, the composition comprising:
a difunctional urethane, acrylate, epoxy, vinyl, vinyl-ether and/or polyester oligomer present in an amount between about 20% to 80% by weight;
a monofunctional urethane, acrylate, epoxy, vinyl, vinyl-ether and/or polyester monomer present in an amount between about 10% to 70% by weight;
a difunctional urethane, acrylate, epoxy, vinyl, vinyl-ether and/or polyester monomer (or cross-linking agent) present in an amount between about 1% to 20% by weight;
a wetting, flow and/or leveling promoter or promotion agent present in an amount between about 0.01% to 10% by weight;
a first photoinitiator for a first range of wavelengths and present in an amount between about 1% to 20% by weight;
a second photoinitiator for a second range of wavelengths and present in an amount between about 1% to 20% by weight;
a reducing agent present in an amount between about 0.01% to 5% by weight; and
a solvent or a viscosity or rheology modifier present in an amount between about 0.5% to 5% by weight.

Referring to the Examples 1-8, and to Examples 9-15 described below, a representative binding medium and/or dielectric ink composition may comprise, for example and without limitation, one or more of the following: a monofunctional, difunctional or trifunctional oligomer which may be a urethane, acrylate, epoxy, vinyl, vinyl-ether and/or polyester oligomer; a monofunctional monomer which may be a urethane, acrylate, epoxy, vinyl, vinyl-ether and/or polyester monomer; a difunctional or trifunctional monomer (also referred to equivalently as a cross-linking agent), which also may be a urethane, acrylate, epoxy, vinyl, vinyl-ether and/or polyester monomer; a wetting, flow and/or leveling promoter or promotion agent; one or more photoinitiators and/or a thermal initiators; a viscosity or rheology modifier; and in some instances, various solvents and various other additives such as a reducing agent or a phenol additive. A representative binding medium and/or dielectric ink composition may be uv-curable (e.g., further comprising a photoinitiator responsive to light having wavelengths in the uv range or bands), and/or thermally-curable. Representative examples and characteristics of each of these compounds, agents, polymers or polymeric precursors are discussed in greater detail below. Unless otherwise specified, all percentages are by weight in and with reference to the completed composition.

A representative difunctional acrylate oligomer is utilized in exemplary embodiments which has a moderate molecular weight (e.g., 1000-5000 Daltons), with excellent clarity, excellent adhesion, high flexibility and good water resistance properties in concentrations in the ink formulation between about 20% to 80% by weight, or more particularly between about 30% to 70% by weight, or more particularly between about 40% to 60% by weight, or more particularly between about 45% to 55% by weight, or more particularly between about 47.5% to 52.5% by weight, or more particularly between about 50% to 51% by weight, or more particularly about 50.5% by weight, for example and without limitation. Examples of such a difunctional acrylate oligomer include without limitation, difunctional aliphatic urethane acrylate oligomers or difunctional aliphatic polycarbonate urethane acrylate oligomers, such as CN 9030, CN 2921, or CN 9001, all from Sartomer USA, LLC (of Exton, Pa., USA). Other monofunctional, difunctional or trifunctional oligomers may also be utilized, including aliphatic or aromatic urethane, acrylate, epoxy, vinyl, vinyl-ether and/or polyester oligomers, for example and without limitation. With respect to the various weight percentages for a difunctional acrylate oligomer, those percentages may also include some other compounds; for example, CN 9030 from Sartomer may contain up to about 10% by weight of a monomer. As a result, all weight percentages should be interpreted to be based upon commercially available component compositions, e.g., of the exemplary 45%-55% by weight of a difunctional acrylate oligomer available as CN 9030, as much as 10% of that commercially available component may be comprised of one or more other compounds or compositions such as a monomer, for example and without limitation.

A representative monofunctional acrylate monomer is utilized in exemplary embodiments with excellent clarity, excellent adhesion, high flexibility and good water resistance properties along with low shrinkage during curing with moderate surface energy (about 27-40 dynes/cm) before curing in concentrations in the completed ink formulation between 10% to 70%, or more particularly between about 15% to 50% by weight, or more particularly between about 20% to 40% by weight, or more particularly between about 25% to 35% by weight, or more particularly between about 27.5% to 32.5% by weight, or more particularly between about 28% to 30% by weight, or more particularly about 29.0% by weight, for example and without limitation. Examples of such a monofunctional acrylate monomer include without limitation, acrylate monomers such as isophoryl acrylate monomer or an acrylate ester monomer, including 3,3,5 trimethyl cyclohexanol acrylate monomers such as SR 420 and CN 420 from Sartomer USA, LLC. Other monofunctional monomers may also be utilized, including aliphatic or aromatic urethane, acrylate, epoxy, vinyl, vinyl-ether and/or polyester monomers, for example and without limitation. Vinyl monomers, cyclic and aliphatic epoxide monomers and resins, and vinyl-ether monomers may include mono- and di-vinyl pyrollidone and vinyl caprolactam, for example and without limitation.

A representative difunctional monomer (or cross-linking agent) is utilized in exemplary embodiments with a comparatively fast cure response, low volatility, good adhesion and low shrinkage with moderate surface energy (about 27-40 dynes/cm) before curing, such as a difunctional alkoxylated acrylate monomer or a difunctional methacrylate monomer in concentrations in the completed ink formulation between 1% to 20%, or more particularly between about 1.0% to 15% by weight, or more particularly between about 1.0% to 10% by weight, or more particularly between about 2.5% to 7.5% by weight, or more particularly between about 3.0% to 6.0% by weight, or more particularly between about 3.5% to 5.5% by weight, or more particularly about 4.5% by weight, for example and without limitation. Examples of such a difunctional monomer (or cross-linking agent) include without limitation 1,6-hexandiol diacrylate (HDDA) available from Sartomer USA, LLC under the trade name SR 238 or alkoxylated (either propoxylated or ethoxylated) hexandiol acrylates such as CD 560, CD 561, CD 562, CD 563 and CD 564, also from Sartomer USA, LLC. Higher order functional monomers may also be utilized equivalently, such as tri-functional monomers, etc., including aliphatic or aromatic urethane, acrylate, epoxy, vinyl, vinyl-ether and/or polyester monomers, for example and without limitation.

Also in exemplary or representative embodiments, to improve surface wetting and film formation, various surfactants and other flow aids may also be utilized, particularly for printing and coating applications, such as a fluorosurfactant, an ethoxylated nonionic fluorosurfactant, a short-chain perfluoro-based ethoxylated nonionic fluorosurfactant, for example and without limitation. Such surfactants include, also for example and without limitation: Dupont Zonyl FSO, Dupont Capstone® FS-65, Dupont Capstone® FS-30, Dupont Capstone® FS-3100 (from E. I. du Pont de Nemours and Company of Wilmington, Del., USA); Chemguard S-550-100, Chemguard S-554-100, and Chemguard S-559-100 (from Chemguard Inc. of Mansfield, Tex., USA); Advanced Polymer Inc. APFS-71S, and Advanced Polymer Inc. APFS-73S (from Advanced Polymer Inc. of Carlstadt, N.J., USA).

A representative wetting, flow and leveling promotion agent is utilized in exemplary embodiments such as an acrylate-based flow and leveling agent in concentrations in the completed ink formulation between 0.01% and 10%, or more particularly between about 0.1% to 5.0% by weight, or more particularly between about 0.5% to 3.0% by weight, or more particularly between about 0.5% to 2.0% by weight, or more particularly between about 0.7% to 1.5% by weight, or more particularly between about 0.9% to 1.3% by weight, or more particularly about 1.1% by weight, for example and without limitation. Copolymers of ethyl acrylate and 2-ethylhexyl acrylate are examples of this type of flow and leveling promotion agent, such as those available from Cytec Industries Inc. (of Woodland Park, N.J. US) under the tradenames Modaflow and Modaflow 2100, also for example and without limitation.

Representative photoinitiator compounds, in various exemplary or representative embodiments, include one or more first photoinitiators for a first band or range of wavelengths such as, for example, α-hydroxyketone class photoinitiators sensitive to comparatively shorter uv wavelengths, such as shorter than about 340-380 nm (e.g., one or more absorption peaks at about 245 nm, 280 nm and 331 nm), and in concentrations in the completed ink formulation ranging from 1% to 20%, or more particularly between about 5.0% to 15% by weight, or more particularly between about 7.5% to 12.5% by weight, or more particularly between about 8.0% to 12.0% by weight, or more particularly between about 9.0% to 11.0% by weight, or more particularly between about 9.5% to 10.5% by weight, or more particularly about 10.0% by weight, for example and without limitation. Examples of such α-hydroxyketone class photoinitiators include without limitation 2-hydroxy-2-methyl-1-phenyl-1-propanone (sold as Darocur 1173 from BASF (BASF SE, Ludwigshafen, Germany)), 1-hydroxy-cyclohexyl-phenyl-ketone (sold as Irgacure 184, also from BASF), diethoxy acetophenone, and α-dimethoxy-alpha-phenylacetophenone (sold as Irgacure 651, also from BASF, and also known as 2,2-Dimethoxy-1,2-diphenylethan-1-one).

Additional exemplary or representative photoinitiator compounds, in various exemplary or representative embodiments, include one or more second photoinitiators for a second band or range of wavelengths such as, for example, α-aminoketone class photoinitiators sensitive to uv wavelengths between about 250 nm and 450 nm (e.g., one or more absorption peaks at about 233 nm and 324 nm), for improved depth cure in concentrations in the completed ink formulation ranging from 0.05% to 10%, or more particularly between about 2.0% to 8% by weight, or more particularly between about 3.0% to 7.0% by weight, or more particularly between about 3.5% to 6.5% by weight, or more particularly between about 4.0% to 6.0% by weight, or more particularly between about 4.5% to 5.5% by weight, or more particularly about 5.0% by weight, for example and without limitation. Examples of such α-aminoketone class photoinitiators include without limitation 2-benzyl-2-(dimethylamino)-1-[4-(4-morpholinyl) phenyl]-1-butanone (sold as Irgacure 369 from BASF), 2-methyl-1-[4-(methylthio)phenyl]-2-(4-morpholinyl)-1-propanone (sold as Irgacure 907 from BASF), 2-dimethylamino-2-(4-methyl-benzyl)-1-(4-morpholin-4-yl-phenyl)-butanone (sold as Irgacure 379, also from BASF), along with other α-aminoketone photoinitiators such as Irgacure 389, also from BASF. Depending upon the selection of the first photoinitiator and its sensitivity to various wavelength bands or ranges (absorption spectra), other α-hydroxyketone class photoinitiators may also be utilized as the second photoinitiators, including alpha α-dimethoxy-alpha-phenylacetophenone (sold as Irgacure 651, also from BASF).

Additional exemplary or representative photoinitiator compounds also may be utilized in various exemplary or representative embodiments, including one or more bis acyl phosphine (BAPO) class photoinitiators sensitive to UV wavelengths between 290 nm and 400 nm (e.g., one or more absorption peaks at about 295 nm and 370 nm) also for improved depth cure in concentrations in the completed ink formulation ranging from 0.05% to 10%, for example and without limitation. Examples of such a bis acyl phosphine class photonitiators include Irgacure 819 and Darocure 2100 from BASF.

More generally, and in another exemplary or representative embodiment, such as for added toughness and/or water resistance, additional cross-linking may be induced in the difunctional acrylate oligomer and/or difunctional monomer. For example, a thermal initiator or a photoinitiator may be utilized. For example, the thermal initiator or a photoinitiator may comprise at least one thermal initiator or photoinitiator selected from the group consisting of: 1,1-bis(tert-butylperoxy)-3,3,5-trimethylcyclohexane, 1,1′-azobis(cyclohexanecarbonitrile), benzoyl peroxide, tert-butyl peroxy-2 ethylhexanoate, 1,1-Di(tert-butylperoxy)-3,3,5-trimethylcyclohexane, α-hydroxyketones, phenylglyoxylates, benzyldimethyl-ketals, α-aminoketones, mono acyl phosphines, bis acyl phosphines, phosphine oxides, metallocenes, iodonium salts, and mixtures thereof. For example and without limitation, a peroxide curing agent (thermal curing agent) that may be utilized includes tert-butyl peroxy-2 ethylhexanoate and 1,1-Di(tert-butylperoxy)-3,3,5-trimethylcyclohexane in a 75% solution of dibutyl phthalate (marketed as Trigonox KSM by Akzo Nobel Chemicals B. V.). Other uv photo free radical photo initiators may also be utilized. Also for example, the thermal initiators are typically triggered during an optional heat curing of the printed conductor and/or dielectric (e.g., dielectric layer).

In yet another exemplary or representative embodiment, such as for added toughness and/or solvent resistance, a monofunctional, difunctional or trifunctional monomer may be utilized additionally, such as an acrylate and/or vinyl ether monomer. Polymerization of such a monomer, oligomer or polymer may be free radical-based or cationic-based (i.e., free radical and/or cationic initiated monomers, oligomers and polymers). For example, the monomer may comprise at least one monomer selected from the group consisting of: n-vinyl pyrollidone (NVP), hexandiol diacrylate (HDDA), alkoxylated HDDA, ethoxylated HDDA, propoxylated HDDA, isobornyl acrylate (IBOA), and mixtures thereof. Examples of such monofunctional acrylate monomers include without limitation, acrylate monomers such as isophoryl acrylate monomer or an acrylate ester monomer, including 3,3,5 trimethyl cyclohexanol acrylate monomers such as SR 420, CN 420, CD 420 from Sartomer USA, LLC. Examples of such a difunctional alkoxylated acrylate monomer or a difunctional methacrylate monomer (or cross-linking agent) include without limitation 1,6-hexandiol diacrylate (HDDA) available from Sartomer USA, LLC under the trade name SR 238 or alkoxylated (either propoxylated or ethoxylated) hexandiol acrylates such as CD 560, CD 561, CD 562, CD 563 and CD 564, also from Sartomer USA, LLC. Higher order functional monomers may also be utilized equivalently, such as tri-functional monomers, etc. Additional cross-linking of such monomers between and around the oligomers may be provided using the various thermal initiators or photoinitiators, such a benzoyl peroxide, imonium and/or sulfonium salt initiators, and various uv photo free radical photoinitiators.

Also in representative embodiments, various additives may also be utilized, such as antioxidants or other reducing agents, such as methyl ethyl hydroquinone (MEHQ), or butylated hydroxytoluene (BHT). Another additive which has been utilized includes a hindered phenol additive, such as for improving uv exposure (environmental exposure) and heat aging properties. Levels in the formula can range from 0.5-5%, for example and without limitation. Examples of such a hindered phenol additive include without limitation Irganox 1010 or Irganox 135, both available from BASF.

Viscosity or rheological additives may also be added in exemplary embodiments for improved printability and holdout properties, such as a fumed silica at levels from 0.5-5%. Examples of such a rheological additive include Cabosil EH-5 fumed silica or Cabosil HP-60 fumed silica, both available from Cabot Corp (of Boston, Mass., USA).

One or more solvents (as first, second or third solvents) may be used equivalently as solvents, rheology (or viscosity) modifiers, flow and leveling agents, and/or wetting agents, such as for different types of printing, including screen, flexographic, and gravure printing, for example and without limitation. Representative or exemplary solvents may include, for example and without limitation: water; alcohols such as methanol, ethanol, N-propanol (including 1-propanol, 2-propanol (isopropanol or IPA), 1-methoxy-2-propanol), butanol (including 1-butanol, 2-butanol (isobutanol)), pentanol (including 1-pentanol, 2-pentanol, 3-pentanol), hexanol (including 1-hexanol, 2-hexanol, 3-hexanol), octanol, N-octanol (including 1-octanol, 2-octanol, 3-octanol), tetrahydrofurfuryl alcohol (THFA), cyclohexanol, cyclopentanol, terpineol, 2-methyl-2-propanol, 2,3-butanediol, 1-methylcyclohexanol, 1-ethynyl-1-cyclohexanol, 3,3,4-trimethyl-2-pentanol, 1,4-butanediol, triethanolamine; benzene-based compounds and benzene derivatives such as parachlorobenzotrifluoride (1-chloro-4-(trifluoromethyl)benzene); butane-based compounds including 2-bromo-2,3-dimethylbutane; lactones such as butyl lactone; ethers such as methyl ethyl ether, diethyl ether, ethyl propyl ether, and polyethers; ketones, including diketones and cyclic ketones, such as cyclohexanone, cyclopentanone, cycloheptanone, cyclooctanone, acetone, benzophenone, acetylacetone, acetophenone, cyclopropanone, isophorone, methyl ethyl ketone; esters such ethyl acetate, dimethyl adipate, propylene glycol monomethyl ether acetate, dimethyl glutarate, dimethyl succinate, glycerin acetate, carboxylates; glycols such as ethylene glycols, diethylene glycols, polyethylene glycols, propylene glycols, dipropylene glycols, glycol ethers, glycol ether acetates; carbonates such as propylene carbonate; glycerols such as glycerin; n-methylpyrrolidone, acetonitrile, tetrahydrofuran (THF), dimethyl formamide (DMF), N-methyl formamide (NMF), dimethyl sulfoxide (DMSO); acids, including organic acids such as carboxylic acids, dicarboxylic acids, tricarboxylic acids, alkyl carboxylic acids, acetic acid, oxalic acid, mellitic acid, formic acid, chloroacetic acid, benzoic acid, trifluoroacetic acid, propanoic acid, butanoic acid; bases such as ammonium hydroxide, sodium hydroxide, potassium hydroxide; and mixtures thereof. In addition, a solvent may also function as a viscosity modifier and vice-versa, such as cyclohexanol, terpineol and n-methylpyrrolidone, for example and without limitation.

In addition to those described above, one or more viscosity modifiers, binders, resins or thickeners (as a viscosity modifier) may be used, for example and without limitation: polymers (or equivalently, polymeric precursors or polymerizable precurors) such as acrylate and (meth)acrylate polymers and copolymers; fumed silica (such as Cabosil), silica powders; and mixtures thereof. As mentioned above, some of the viscosity modifiers may also function as solvents and vice-versa, such as the various glycols, and therefore are included in the various listings of exemplary solvents and viscosity modifiers.

More generally and for completeness of this description, one or more viscosity modifiers, binders, resins or thickeners (as a viscosity modifier) may be used, for example and without limitation: polymers, copolymers, monomers, and oligomers (or equivalently, polymeric precursors or polymerizable precurors), including acrylate-, vinyl- and vinyl ether-based monomers, oligomers, polymers, copolymers and polymeric precursors such as polyvinyl pyrrolidone (also referred to or known as polyvinyl pyrrolidinone), polyvinyl acetate, polyvinyl alcohol, poly-2-vinylpyridine, poly-4-vinylpyridine, polyvinylimidazole, poly-4-vinylphenol, polyimide polymers and copolymers (including aliphatic, aromatic and semi-aromatic polyimides), acrylate and (meth)acrylate polymers and copolymers; cycloaliphatic epoxides; glycols such as ethylene glycols, diethylene glycol, polyethylene glycols, propylene glycols, dipropylene glycols, glycol ethers, glycol ether acetates; clays such as hectorite clays, garamite clays, organo-modified clays; saccharides and polysaccharides such as guar gum, xanthan gum; celluloses and modified celluloses such as hydroxy methylcellulose, methylcellulose, ethyl cellulose, propyl methylcellulose, methoxy cellulose, methoxy methylcellulose, methoxy propyl methylcellulose, hydroxy propyl methylcellulose, carboxy methylcellulose, hydroxy ethylcellulose, ethyl hydroxyl ethylcellulose, cellulose ether, cellulose ethyl ether, chitosan; fumed silica (such as Cabosil), silica powders and modified ureas such as BYK® 420 (available from BYK Chemie GmbH); and mixtures thereof. As mentioned above, some of the viscosity modifiers may also function as solvents and vice-versa, such as the various glycols, and therefore are included in the various listings of exemplary solvents and viscosity modifiers. It should be noted that the selection of any of these various viscosity modifiers, binders, resins or thickeners should be empirically based and depends upon the selection of other compounds utilized in the selected binding medium.

In another exemplary or representative embodiment, such as for thermoforming applications, additional polymers or polymeric precursors which may be utilized includes a polyvinyl pyrrolidone and polyvinyl acetate copolymer, such as BASF Kollidon VA 64 or Luvitec VA 64 (BASF SE, Ludwigshafen, Germany), for example and without limitation.

### Binding Medium Example 9

A binding medium composition which may be utilized as a dielectric ink, the composition comprising:
a difunctional acrylate oligomer present in an amount between about 20% to 80% by weight and comprising a difunctional aliphatic or aromatic urethane acrylate oligomer or polycarbonate-urethane acrylate oligomer;
a monofunctional acrylate monomer present in an amount between about 10% to 70% by weight and comprising an isophoryl acrylate monomer, a methacrylate monomer, or an acrylate ester monomer;
a difunctional monomer (or cross-linking agent) present in an amount between about 1% to 20% by weight and comprising a difunctional alkoxylated acrylate or diacrylate or a difunctional methacrylate or diacrylate;
a wetting, flow and/or leveling promoter or promotion agent present in an amount between about 0.01% to 10% by weight;
a first photoinitiator for a first range of wavelengths and present in an amount between about 1% to 20% by weight; and
a second photoinitiator for a second range of wavelengths and present in an amount between about 0.05% to 10% by weight.

### Binding Medium Example 10

A binding medium composition which may be utilized as a dielectric ink, the composition comprising:
a difunctional acrylate oligomer present in an amount between about 30% to 70% by weight and comprising a difunctional aliphatic or aromatic urethane acrylate oligomer or polycarbonate-urethane acrylate oligomer;
a monofunctional acrylate monomer present in an amount between about 15% to 50% by weight and comprising an isophoryl acrylate monomer, a methacrylate monomer, or an acrylate ester monomer;
a difunctional monomer (or cross-linking agent) present in an amount between about 1% to 15% by weight and comprising a difunctional alkoxylated acrylate or diacrylate or a difunctional methacrylate or diacrylate;
a wetting, flow and/or leveling promoter or promotion agent present in an amount between about 0.1% to 5.0% by weight and comprising a polymer or copolymer of ethyl acrylate or 2-ethylhexyl acrylate;
a first photoinitiator for a first range of wavelengths and present in an amount between about 5.0% to 15% by weight and comprising an α-hydroxyketone; and
a second photoinitiator for a second range of wavelengths and present in an amount between about 2.0% to 8.0% by weight and comprising an α-aminoketone.

### Binding Medium Example 11

A binding medium composition which may be utilized as a dielectric ink, the composition comprising:
a difunctional acrylate oligomer present in an amount between about 40% to 60% by weight and comprising a difunctional aliphatic or aromatic urethane acrylate oligomer or polycarbonate-urethane acrylate oligomer;
a monofunctional acrylate monomer present in an amount between about 20% to 40% by weight and comprising an isophoryl acrylate monomer, a methacrylate monomer, or an acrylate ester monomer;
a difunctional monomer (or cross-linking agent) present in an amount between about 1% to 10% by weight and comprising a difunctional alkoxylated acrylate or diacrylate or a difunctional methacrylate or diacrylate;
a wetting, flow and/or leveling promoter or promotion agent present in an amount between about 0.5% to 3.0% by weight and comprising a polymer or copolymer of ethyl acrylate or 2-ethylhexyl acrylate;
a first photoinitiator for a first range of wavelengths and present in an amount between about 7.5% to 12.5% by weight and comprising an α-hydroxyketone; and
a second photoinitiator for a second range of wavelengths and present in an amount between about 3.0% to 7.0% by weight and comprising an α-aminoketone.

### Binding Medium Example 12

A binding medium composition which may be utilized as a dielectric ink, the composition comprising:
a difunctional acrylate oligomer present in an amount between about 45% to 55% by weight and comprising a difunctional aliphatic polycarbonate urethane acrylate oligomer;
a monofunctional acrylate monomer present in an amount between about 25% to 35% by weight and comprising an isophoryl acrylate monomer, a methacrylate monomer, or an acrylate ester monomer;
a difunctional monomer (or cross-linking agent) present in an amount between about 2.5% to 7.5% by weight and comprising a difunctional alkoxylated acrylate or diacrylate or a difunctional methacrylate or diacrylate;
a wetting, flow and/or leveling promoter or promotion agent present in an amount between about 0.5% to 2.0% by weight and comprising a polymer or copolymer of ethyl acrylate or 2-ethylhexyl acrylate;
a first photoinitiator for a first range of wavelengths and present in an amount between about 8.0% to 12% by weight and comprising an α-hydroxyketone; and
a second photoinitiator for a second range of wavelengths and present in an amount between about 3.5% to 6.5% by weight and comprising an α-aminoketone.

### Binding Medium Example 13

A binding medium composition which may be utilized as a dielectric ink, the composition comprising:
a difunctional acrylate oligomer present in an amount between about 47.5% to 52.5% by weight and comprising a difunctional aliphatic polycarbonate urethane acrylate oligomer;
a monofunctional acrylate monomer present in an amount between about 27.5% to 32.5% by weight and comprising an isophoryl acrylate monomer, a methacrylate monomer, or an acrylate ester monomer;
a difunctional monomer (or cross-linking agent) present in an amount between about 3.0% to 6.0% by weight and comprising a difunctional alkoxylated acrylate or diacrylate or a difunctional methacrylate or diacrylate;
a wetting, flow and/or leveling promoter or promotion agent present in an amount between about 0.7% to 1.5% by weight and comprising a polymer or copolymer of ethyl acrylate or 2-ethylhexyl acrylate;
a first photoinitiator for a first range of wavelengths and present in an amount between about 9.0% to 11% by weight and comprising an α-hydroxyketone; and
a second photoinitiator for a second range of wavelengths and present in an amount between about 4.0% to 6.0% by weight and comprising an α-aminoketone.

### Binding Medium Example 14

A binding medium composition which may be utilized as a dielectric ink, the composition comprising:
a difunctional acrylate oligomer present in an amount between about 50.0% to 51.0% by weight and comprising a difunctional aliphatic polycarbonate urethane acrylate oligomer;
a monofunctional acrylate monomer present in an amount between about 28.0% to 30.0% by weight and comprising an isophoryl acrylate monomer, a methacrylate monomer, or an acrylate ester monomer;
a difunctional monomer (or cross-linking agent) present in an amount between about 3.5% to 5.5% by weight and comprising a difunctional alkoxylated acrylate or diacrylate or a difunctional methacrylate or diacrylate;
a wetting, flow and/or leveling promoter or promotion agent present in an amount between about 0.9% to 1.3% by weight and comprising a polymer or copolymer of ethyl acrylate or 2-ethylhexyl acrylate;
a first photoinitiator for a first range of wavelengths and present in an amount between about 9.5% to 10.5% by weight and comprising an α-hydroxyketone; and
a second photoinitiator for a second range of wavelengths and present in an amount between about 4.5% to 5.5% by weight and comprising an α-aminoketone.

### Binding Medium Example 15

A binding medium composition which may be utilized as a dielectric ink, the composition comprising:
a difunctional acrylate oligomer present in an amount of about 50.5% by weight and comprising a difunctional aliphatic polycarbonate urethane acrylate oligomer;
a monofunctional acrylate monomer present in an amount of about 29.0% by weight and comprising an isophoryl acrylate monomer, a methacrylate monomer, or an acrylate ester monomer;
a difunctional monomer (or cross-linking agent) present in an amount of about 4.5% by weight and comprising a difunctional alkoxylated acrylate or diacrylate or a difunctional methacrylate or diacrylate;
a wetting, flow and/or leveling promoter or promotion agent present in an amount of about 1.1% by weight and comprising a polymer or copolymer of ethyl acrylate or 2-ethylhexyl acrylate;
a first photoinitiator for a first range of wavelengths and present in an amount of about 10.0% by weight and comprising an α-aminoketone; and
a second photoinitiator for a second range of wavelengths and present in an amount of about 5.0% by weight and comprising an α-aminoketone.

As mentioned above, a conductive ink may be formed by adding conductive particles, including conductive particles such as conductive spheres, flakes, ribbons, wires, fibers or threads to the binding medium composition described herein, such as metallic, carbon-based, metallic alloy, carbon alloy, or various conductive oxide particles.

As used herein, the terminology “conductive particles” should be understood to mean and include conductive particulates of any shapes and sizes, including a wide variation in shapes and sizes, such as conductive spheres (or spheroids), flakes, ribbons, wires, fibers or threads, such as metallic particles, graphene flakes, graphene ribbons, metallic nanowires, metallic nanofibers, etc., for example and without limitation. Such conductive particles may also be amorphous, or crystalline, or a combination of both amorphous and crystalline (e.g., crystal grains typical of metals). The typical range of sizes (in any given dimension) for such conductive particles extends from the sub-nanometer (Angstrom) to the hundreds of microns, depending upon the type of conductive particles selected, and all such variations are within the scope of the present disclosure.

For example, in various representative embodiments, a combination of silver particles and graphene particles are utilized. The silver conductive particles typically have a wide variety of shapes and sizes, and depending on the selected vendor and quality, may range in size from about 3-400 nm to about 30 microns, for example and without limitation. Similarly, the graphene conductive particles typically are specified as graphene flakes, and may be further specified by surface area and/or size. In various representative embodiments, M-series graphene flakes typically have about a 6 nm thickness on average and a width or length from about 5 microns to about 30-50 microns, while C-series graphene flakes typically have about a 2 nm thickness on average and a width or length of about 1-2 microns, with average particles sizes ranging from about 5 to 25 microns, for example and without limitation. In other various representative embodiments, graphene flakes having fewer carbon layers may have sub-nanometer thickness, such as on the order of 3-4 Angstroms thick, e.g., 3.35 Angstroms. All such variations are within the scope of the present disclosure.

Similarly, when conductive (e.g., metallic) nanowires or nanofibers are selected as conductive particles, exemplary metallic nanowires or nanofibers may have an average length on the order of about 10μ to about 100μ and an average diameter on the order of about 10 nm to about 120 nm, with some as long as 200 nm. The lengths and diameters of the metallic nanowires or nanofibers may vary, for example: metallic nanowires or nanofibers may have lengths between about 1μ and about 250μ and diameters between about 10 nm and about 500 nm; or more particularly, may have lengths between about 10μ and about 150μ and diameters between about 5 nm and about 250 nm; or more particularly, may have lengths between about 10μ and about 100μ and diameters between about 10 nm and about 100 nm; or more particularly, may have lengths between about 10μ and about 80μ and diameters between about 10 nm and about 80 nm; or more particularly, may have lengths between about 1μ and about 60μ and diameters between about 10 nm and about 200 nm; or more particularly, may have lengths between about 10μ and about 70μ and diameters between about 25 nm and about 60 nm; or more particularly, the plurality of metallic nanofibers may have lengths between about 40μ and about 60μ and diameters between about 15 nm and about 40 nm and/or have lengths between about 10μ and about 25μ and diameters between about 10 nm and about 15 nm. All such variations are also within the scope of the present disclosure. Metallic nanowires or nanofibers have been obtained from vendors such as NanoGap Subnmparticles of Spain, US and UK and having an office in San Francisco, Calif. USA; Blue Nano Inc. of Charlotte and Cornelius, N.C. USA; Zhejiang Kechuang Advanced Materials Technology Co. Ltd. of Zhejiang, China; and ACS Material LLC, having offices in Medford, Mass. and Ames, Iowa, USA. For example, metallic nanofibers 100 exemplary include A W030 silver fibers obtained from Zhejiang Kechuang Advanced Materials Technology Co. Ltd.

The representative or exemplary conductive particles may be comprised of a wide variety of materials, and may be referred to as “metallic” to indicate substantially high conductivity, for example. In an exemplary embodiment, conductive particles are comprised of one or more metals (e.g., aluminum, copper, silver, gold, nickel, palladium, tin, platinum, lead, zinc, silver coated copper, etc.), alone or in combination with each other, such as an alloy or a coating (e.g., silver coated copper), and may also include various metal oxides, such as indium tin oxide (ITO) and/or antimony tin oxide (ATO), for example and without limitation. Combinations of different types of conductors and/or conductive compounds or materials (e.g., ink, polymer, graphene, carbon nanotubes, elemental metal, elemental carbon etc.) may also be utilized to form the conductive particles, flakes, wires or threads. Multiple layers and/or types of metal or other conductive materials may be combined to form the conductive particles, flakes, wires or threads. In an exemplary embodiment, for example, a combination of silver particles (or silver coated copper particles) and graphene particles are utilized.

In an exemplary embodiment, in addition to the conductors described above, carbon nanotubes (CNTs), nanoparticle or nanofiber metals, polyethylene-dioxythiophene (e.g., AGFA Orgacon), a combination of poly-3,4-ethylenedioxythiophene and polystyrenesulfonic acid (marketed as Baytron P and available from Bayer AG of Leverkusen, Germany), a polyaniline or polypyrrole polymer, may also be utilized.

In an exemplary or representative embodiment, silver conductive particles and flakes have been utilized, generally having an average diameter between about 2 microns to about 20 microns, along with graphene particles and flakes, generally having an average thickness of about 2 nm and an average diameter of about 1-2 microns. Examples of such silver conductive particles and flakes include SF-1, SF-80, SF-52, SF-25, SF 125, SF-65, and SF-120, available from Ferro Corp. (of Mayfield Heights, Ohio, US). Examples of such graphene particles and flakes include GNP C-300, GNP C-500, and GNP C-750 series, along with GnP-M-5, GnP-M-15, GnP-M-25, GnP-H-5, GnP-H-15, GnP-H-25, available from XG Sciences, Inc. (of Lansing, Mich. US).

In an exemplary or representative embodiment, the percentage of conductive particles, by weight, dispersed in the (common) binding medium composition, will impact the degree of conductivity of the resulting conductor produced through use of the conductive ink composition. In an exemplary or representative embodiment, the conductive particles are present in an amount between about 50% to 95% by weight, or more particularly in an amount between about 60% to 90% by weight, or more particularly in an amount between about 70% to 90% by weight, or more particularly in an amount between about 75% to 85% by weight, or more particularly in an amount between about 77.5% to 82.5% by weight, or more particularly in an amount between about 79% to 81% by weight, or more particularly in an amount of about 80% by weight, for example and without limitation.

When multiple types of conductive particles are utilized, each different type of conductive particle may have various different percentages, by weight, utilized in representative conductive ink compositions, such as about 0.25% graphene particles by weight with the balance comprising silver particles (up to the total percentage of conductive particles to be included in a selected conductive ink composition), such as about 79.75% silver particles by weight when the overall or total percentage of conductive particles is 80% in the selected conductive ink composition, for example and without limitation. More generally, when both silver (or silver coated copper) particles and graphene conductive particles are utilized, the graphene particles may be present in an amount between about 0.001% to 10.0% by weight with the balance comprising silver particles, up to the overall percentage of conductive particles selected for the conductive ink composition. More particularly, the graphene particles may be present in an amount between about 0.01% to 7.5% by weight, or the graphene particles may be present in an amount between about 0.05% to 5.0% by weight, or the graphene particles may be present in an amount between about 0.1% to 2.5% by weight, or the graphene particles may be present in an amount between about 0.15% to 1.0% by weight, or the graphene particles may be present in an amount between about 0.2% to 0.5% by weight, or the graphene particles may be present in an amount between about 0.2% to 0.4% by weight, or the graphene particles may be present in an amount between about 0.2% to 0.3% by weight, or the graphene particles may be present in an amount between about 0.225% to 0.275% by weight, or the graphene particles may be present in an amount of about 0.25% by weight, all with the balance comprising silver particles up to the overall percentage of conductive particles selected for the conductive ink composition, for example and without limitation. As another example and without limitation, silver particles may be present in an amount between about 79.0% to 81.0% by weight and the graphene particles may be present in an amount between about 0.001% to 2.0% by weight, for an overall percentage of conductive particles in the conductive ink composition between about 79.001% to about 83%, with the balance of the conductive ink composition comprising the common binding medium composition discussed above, with corresponding weight percentages, such as described in Examples 16-26.

The various and relative percentages of metallic and carbon-based conductive particles in the exemplary or representative conductive ink composition embodiments, such as silver and graphene, may be adjusted to modify conductivity and printability, for example and without limitation. For example, the addition of a comparatively small percentage of graphene particles, while potentially reducing conductivity slightly, may significantly improve printability and yield of the conductive wires, traces or layers in the resulting device. In addition, the graphene particles have also been shown to improve the flexibility of the cured conductive ink, which may be very significant in selected applications.

Serendipitously, it has been discovered empirically by the inventors hereof that the addition of graphene particles, specifically, and not graphite or other forms of carbon, improves the ultraviolet curability of the representative conductive ink compositions which includes a comparatively heavy loading of non-transparent silver conductive particles. In contrast, prior art conductive inks which include carbon generally, especially to replace metallic particles such as silver, are generally not uv curable. The exemplary conductive ink composition embodiments are therefore highly unique and novel, providing a uv curable acrylate-based conductive ink having a combination of both graphene particles and metallic conductive particles such as silver conductive particles.

### Conductive Ink Example 16

A conductive ink comprising:
a plurality of conductive particles, flakes, wires or threads, present in an amount between about 50% to 95% by weight; and
with the balance comprising a binding medium, the binding medium comprising:
a difunctional urethane, acrylate, epoxy, vinyl, vinyl-ether and/or polyester oligomer present in an amount in the binding medium between about 20% to 80% by weight;
a monofunctional urethane, acrylate, epoxy, vinyl, vinyl-ether and/or polyester monomer present in an amount in the binding medium between about 10% to 70% by weight;
a difunctional monomer (or cross-linking agent) present in an amount in the binding medium between about 1% to 20% by weight;
a wetting, flow and/or leveling promoter or promotion agent present in an amount in the binding medium between about 0.1% to 10% by weight;
a first photoinitiator for a first range of wavelengths and present in an amount in the binding medium between about 1% to 20% by weight; and
a second photoinitiator for a second range of wavelengths and present in an amount in the binding medium between about 1% to 20% by weight.

### Conductive Ink Example 17

A conductive ink comprising:
a plurality of conductive particles, flakes, wires or threads, present in an amount between about 50% to 95% by weight; and
with the balance comprising a binding medium, the binding medium comprising:
a difunctional acrylate oligomer present in an amount in the binding medium between about 20% to 80% by weight and comprising a difunctional aliphatic or aromatic urethane acrylate oligomer or polycarbonate-urethane acrylate oligomer;
a monofunctional acrylate monomer present in an amount in the binding medium between about 10% to 70% by weight and comprising an isophoryl acrylate monomer, a methacrylate monomer, or an acrylate ester monomer;
a difunctional monomer (or cross-linking agent) present in an amount in the binding medium between about 1% to 20% by weight and comprising a difunctional alkoxylated acrylate or diacrylate or a difunctional methacrylate or diacrylate;
a wetting, flow and/or leveling promoter or promotion agent present in an amount in the binding medium between about 0.01% to 10% by weight;
a first photoinitiator for a first range of wavelengths and present in an amount in the binding medium between about 1% to 20% by weight; and
a second photoinitiator for a second range of wavelengths and present in an amount in the binding medium between about 0.05% to 10% by weight.

### Conductive Ink Example 18

A conductive ink comprising:
a plurality of conductive particles, flakes, wires or threads, present in an amount between about 60% to 90% by weight; and
with the balance comprising a binding medium, the binding medium comprising:
a difunctional acrylate oligomer present in an amount in the binding medium between about 30% to 70% by weight and comprising a difunctional aliphatic or aromatic urethane acrylate oligomer or polycarbonate-urethane acrylate oligomer;
a monofunctional acrylate monomer present in an amount in the binding medium between about 15% to 50% by weight and comprising an isophoryl acrylate monomer, a methacrylate monomer, or an acrylate ester monomer;
a difunctional monomer (or cross-linking agent) present in an amount in the binding medium between about 1% to 15% by weight and comprising a difunctional alkoxylated acrylate or diacrylate or a difunctional methacrylate or diacrylate;
a wetting, flow and/or leveling promoter or promotion agent present in an amount in the binding medium between about 0.1% to 5.0% by weight and comprising a polymer or copolymer of ethyl acrylate or 2-ethylhexyl acrylate;
a first photoinitiator for a first range of wavelengths and present in an amount in the binding medium between about 5.0% to 15% by weight and comprising an α-hydroxyketone; and
a second photoinitiator for a second range of wavelengths and present in an amount in the binding medium between about 2.0% to 8.0% by weight and comprising an α-aminoketone.

### Conductive Ink Example 19

A conductive ink comprising:
a plurality of conductive particles, flakes, wires or threads, present in an amount between about 70% to 90% by weight; and
with the balance comprising a binding medium, the binding medium comprising:
a difunctional acrylate oligomer present in an amount in the binding medium between about 40% to 60% by weight and comprising a difunctional aliphatic or aromatic urethane acrylate oligomer or polycarbonate-urethane acrylate oligomer;
a monofunctional acrylate monomer present in an amount in the binding medium between about 20% to 40% by weight and comprising an isophoryl acrylate monomer, a methacrylate monomer, or an acrylate ester monomer;
a difunctional monomer (or cross-linking agent) present in an amount in the binding medium between about 1% to 10% by weight and comprising a difunctional alkoxylated acrylate or diacrylate or a difunctional methacrylate or diacrylate;
a wetting, flow and/or leveling promoter or promotion agent present in an amount in the binding medium between about 0.5% to 3.0% by weight and comprising a polymer or copolymer of ethyl acrylate or 2-ethylhexyl acrylate;
a first photoinitiator for a first range of wavelengths and present in an amount in the binding medium between about 7.5% to 12.5% by weight and comprising an α-hydroxyketone; and
a second photoinitiator for a second range of wavelengths and present in an amount in the binding medium between about 3.0% to 7.0% by weight and comprising an α-aminoketone.

### Conductive Ink Example 20

A conductive ink comprising:
a plurality of conductive particles, flakes, wires or threads, present in an amount between about 75% to 85% by weight; and
with the balance comprising a binding medium, the binding medium comprising:
a difunctional aliphatic polycarbonate urethane acrylate oligomer present in an amount in the binding medium between about 45% to 55% by weight;
a monofunctional acrylate monomer present in an amount in the binding medium between about 25% to 35% by weight and comprising an isophoryl acrylate monomer, a methacrylate monomer, or an acrylate ester monomer;
a difunctional monomer (or cross-linking agent) present in an amount in the binding medium between about 2.5% to 7.5% by weight and comprising a difunctional alkoxylated acrylate or diacrylate or a difunctional methacrylate or diacrylate;
a wetting, flow and/or leveling promoter or promotion agent present in an amount in the binding medium between about 0.5% to 2.0% by weight and comprising a polymer or copolymer of ethyl acrylate or 2-ethylhexyl acrylate;
a first photoinitiator for a first range of wavelengths and present in an amount in the binding medium between about 8.0% to 12% by weight and comprising an α-hydroxyketone; and
a second photoinitiator for a second range of wavelengths and present in an amount in the binding medium between about 3.5% to 6.5% by weight and comprising an α-aminoketone.

### Conductive Ink Example 21

A conductive ink comprising:
a plurality of conductive particles, flakes, wires or threads, present in an amount between about 77.5% to 82.5% by weight and comprising silver and graphene; and
with the balance comprising a binding medium, the binding medium comprising:
a difunctional aliphatic polycarbonate urethane acrylate oligomer present in an amount in the binding medium between about 47.5% to 52.5% by weight;
a monofunctional acrylate monomer present in an amount in the binding medium between about 27.5% to 32.5% by weight and comprising an isophoryl acrylate monomer, a methacrylate monomer, or an acrylate ester monomer;
a difunctional monomer (or cross-linking agent) present in an amount in the binding medium between about 3.0% to 6.0% by weight and comprising a difunctional alkoxylated acrylate or diacrylate or a difunctional methacrylate or diacrylate;
a wetting, flow and/or leveling promoter or promotion agent present in an amount in the binding medium between about 0.7% to 1.5% by weight and comprising a polymer or copolymer of ethyl acrylate or 2-ethylhexyl acrylate;
a first photoinitiator for a first range of wavelengths and present in an amount in the binding medium between about 9.0% to 11% by weight and comprising an α-hydroxyketone; and
a second photoinitiator for a second range of wavelengths and present in an amount in the binding medium between about 4.0% to 6.0% by weight and comprising an α-aminoketone.

### Conductive Ink Example 22

A conductive ink comprising:
a plurality of conductive particles, flakes, wires or threads, present in an amount between about 79.0% to 81.0% by weight and comprising silver and graphene; and
with the balance comprising a binding medium, the binding medium comprising:
a difunctional aliphatic polycarbonate urethane acrylate oligomer present in an amount in the binding medium between about 50.0% to 51.0% by weight;
a monofunctional acrylate monomer present in an amount in the binding medium between about 28.0% to 30.0% by weight and comprising an isophoryl acrylate monomer, a methacrylate monomer, or an acrylate ester monomer;
a difunctional monomer (or cross-linking agent) present in an amount in the binding medium between about 3.5% to 5.5% by weight and comprising a difunctional alkoxylated acrylate or diacrylate or a difunctional methacrylate or diacrylate;
a wetting, flow and/or leveling promoter or promotion agent present in an amount in the binding medium between about 0.9% to 1.3% by weight and comprising a polymer or copolymer of ethyl acrylate or 2-ethylhexyl acrylate;
a first photoinitiator for a first range of wavelengths and present in an amount in the binding medium between about 9.5% to 10.5% by weight and comprising an α-hydroxyketone; and
a second photoinitiator for a second range of wavelengths and present in an amount in the binding medium between about 4.5% to 5.5% by weight and comprising an α-aminoketone.

### Conductive Ink Example 23

A conductive ink comprising:
a plurality of conductive particles, flakes, wires or threads, present in an amount of about 80% by weight and comprising silver and graphene; and
with the balance comprising a binding medium, the binding medium comprising:
a difunctional aliphatic polycarbonate urethane acrylate oligomer present in an amount in the binding medium of about 50.5% by weight and comprising a difunctional aliphatic or aromatic urethane acrylate oligomer or polycarbonate-urethane acrylate oligomer;
a monofunctional acrylate monomer present in an amount in the binding medium of about 29.0% by weight and comprising an isophoryl acrylate monomer, a methacrylate monomer, or an acrylate ester monomer;
a difunctional monomer (or cross-linking agent) present in an amount in the binding medium of about 4.5% by weight and comprising a difunctional alkoxylated acrylate or diacrylate or a difunctional methacrylate or diacrylate;
a wetting, flow and/or leveling promoter or promotion agent present in an amount in the binding medium of about 1.1% by weight and comprising a polymer or copolymer of ethyl acrylate or 2-ethylhexyl acrylate;
a first photoinitiator for a first range of wavelengths and present in an amount in the binding medium of about 10.0% by weight and comprising an α-aminoketone; and
a second photoinitiator for a second range of wavelengths and present in an amount in the binding medium of about 5.0% by weight and comprising an α-aminoketone.

The various weight percentages between the conductive particles, flakes, wires or threads and the binding medium may also be reflected in absolute percentages, such as described in Examples 24, 25 and 26, which refer to the same compositions of Examples 21, 22 and 23, and are provided for purposes of explanation and not limitation.

### Conductive Ink Example 24

A conductive ink comprising:
a plurality of conductive particles, flakes, wires or threads, present in an amount between about 77.5% to 82.5% by weight and comprising silver and graphene;
a difunctional aliphatic polycarbonate urethane acrylate oligomer present in an amount between about 9.5% to 10.5% by weight and comprising a difunctional aliphatic or aromatic urethane acrylate oligomer or polycarbonate-urethane acrylate oligomer;
a monofunctional acrylate monomer present in an amount between about 5.5% to 6.5% by weight and comprising an isophoryl acrylate monomer, a methacrylate monomer, or an acrylate ester monomer;
a difunctional monomer (or cross-linking agent) present in an amount between about 0.6% to 1.2% by weight and comprising a difunctional alkoxylated acrylate or diacrylate or a difunctional methacrylate or diacrylate;
a wetting, flow and/or leveling promoter or promotion agent present in an amount between about 0.14% to 0.3% by weight and comprising a polymer or copolymer of ethyl acrylate or 2-ethylhexyl acrylate;
a first photoinitiator for a first range of wavelengths and present in an amount between about 1.8% to 2.2% by weight and comprising an α-hydroxyketone; and
a second photoinitiator for a second range of wavelengths and present in an amount between about 0.8% to 1.2% by weight and comprising an α-aminoketone.

### Conductive Ink Example 25

A conductive ink comprising:
a plurality of conductive particles, flakes, wires or threads, present in an amount between about 79.0% to 81.0% by weight and comprising silver and graphene;
a difunctional aliphatic polycarbonate urethane acrylate oligomer present in an amount between about 10.0% to 10.2% by weight;
a monofunctional acrylate monomer present in an amount between about 5.6% to 6.0% by weight and comprising an isophoryl acrylate monomer, a methacrylate monomer, or an acrylate ester monomer;
a difunctional monomer (or cross-linking agent) present in an amount between about 0.7% to 1.1% by weight and comprising a difunctional alkoxylated acrylate or diacrylate or a difunctional methacrylate or diacrylate;
a wetting, flow and/or leveling promoter or promotion agent present in an amount between about 0.18% to 0.26% by weight and comprising a polymer or copolymer of ethyl acrylate or 2-ethylhexyl acrylate;
a first photoinitiator for a first range of wavelengths and present in an amount between about 1.9% to 2.1% by weight and comprising an α-hydroxyketone; and
a second photoinitiator for a second range of wavelengths and present in an amount between about 0.9% to 1.1% by weight and comprising an α-aminoketone.

### Conductive Ink Example 26

A conductive ink comprising:
a plurality of conductive particles, flakes, wires or threads, present in an amount of about 80% by weight and comprising silver and graphene;
a difunctional aliphatic polycarbonate urethane acrylate oligomer present in an amount in the binding medium of about 10.1% by weight;
a monofunctional acrylate monomer present in an amount in the binding medium of about 5.8% by weight and comprising an isophoryl acrylate monomer, a methacrylate monomer, or an acrylate ester monomer;
a difunctional monomer (or cross-linking agent) present in an amount in the binding medium of about 0.9% by weight and comprising a difunctional alkoxylated acrylate or diacrylate or a difunctional methacrylate or diacrylate;
a wetting, flow and/or leveling promoter or promotion agent present in an amount in the binding medium of about 0.22% by weight and comprising a polymer or copolymer of ethyl acrylate or 2-ethylhexyl acrylate;
a first photoinitiator for a first range of wavelengths and present in an amount in the binding medium of about 2.0% by weight and comprising an α-aminoketone; and
a second photoinitiator for a second range of wavelengths and present in an amount in the binding medium of about 1.0% by weight and comprising an α-aminoketone.

As mentioned above, the exemplary or representative conductive ink compositions provide a surprisingly low impedance or resistance of the resulting conductive wires, lines, traces or layers, several times lower compared to commercially available uv-curable conductive inks and as low as 30 mΩ/□, normalized per mil of thickness. The exemplary or representative conductive ink compositions may also be printed to provide very high resolution, e.g., a 75-76 micron features size, such as a 3 mil wire with a 3 mil separation distance between adjacent wires, for example and without limitation.

As indicated above, various solvents or other viscosity modifiers may also be utilized in the exemplary or representative conductive ink compositions, such as cyclohexanol or parachlorobenzotriflouride, for example and without limitation, such as for use in different types of printing applications.

Following printing, coating, or other application, the exemplary or representative conductive and/or dielectric ink compositions may be cured through a uv cure, a thermal cure, or both a uv and thermal cure. In an exemplary or representative embodiment, the printed conductive ink composition is uv cured for several seconds, followed by a thermal cure, generally over 70° C., or more particularly between 80-140° C., or more particularly between 100-140° C., for 1-4 minutes, for example and without limitation.

One of the most important properties of the various representative binding media, such as when used as transparent uv-curable dielectric inks as disclosed herein, is that the transmissivity is greater than about 99% T when applied in the 0-20 micron cured film thickness range. Transmissivity decreases very slowly as the thickness of the film is increased, such that 40-60 micron films are still approximately 99% T, even when applied in multiple thinner layers.

The viscosity of the various representative conductive inks and transparent uv-curable dielectric inks disclosed herein can be adjusted between 200 (or lower) and 10,000 centipoise (cp) (or higher) by increasing the ratio of monomer to oligomer used in the formulation, or by adding one or more solvents, or by adding one or more viscosity modifiers or thickeners. This permits the formulation of silk screen printable high viscosity formulations greater than about 500 centipoise or flexographic printable low viscosity formulations of less than about 2,000 centipoise. Formulations for use with rotoscreen, flexographic, screen, gravure and other printing and coating technologies are also possible using these viscosity control techniques.

The photoinitiators and/or thermal initiators used in the various representative conductive inks and transparent uv-curable dielectric inks described herein are designed to work at a variety of different film thicknesses required for the different applications described herein, such as for conductive or dielectric films and traces. Excellent surface cure is achieved with the photoinitiators of the various representative conductive inks and transparent uv-curable dielectric inks across all film thicknesses to maximized smoothness, clarity and inter-layer adhesion to subsequently applied layers.

For transparent conductive films, an undercoat or overcoat layer of this the various representative transparent uv-curable dielectric inks disclosed herein provides important and significant properties such as high clarity, exceptional smoothness, moisture resistance and overprintability with both uv and thermally cured inks.

Overprintability with thermally cured inks is a highly unusual attribute of the various representative conductive inks and transparent uv-curable dielectric inks disclosed herein, as generally uv curable inks are not overprintable with anything but another uv curable ink. These unusual adhesion properties greatly widen the range of materials available for use in an optical and/or electrical device constructed with this transparent uv-curable dielectric ink. For example, a thermally cured transparent conductive ink can be applied either before (under) or after (over) the transparent uv-curable dielectric ink or both, permitting the construction of resistive or capacitive touch sensors composed of multiple layers of printed or coated transparent electrodes and dielectrics. Such touch sensors can be applied to any smooth flat surface such as a simple printed graphic, or a complex LCD or other raster display or other active types of electronic displays such as electroluminescent displays or LED displays.

The exceptional smoothness of the cured film produced by the various representative transparent uv-curable dielectric inks disclosed herein improves the clarity of the cured transparent uv-curable dielectric ink and is a byproduct of the excellent flow and leveling properties of the wet ink film. Even lower surface roughness can be achieved by heating the wet film for 30 to 60 seconds at 40° C. to 90° C. before uv curing.

The low relative dielectric constant of the various representative transparent uv-curable dielectric inks disclosed herein, in the range of 3.5 to 4.2, is particularly helpful when constructing capacitive displays. If the dielectric constant of the dielectric in capacitive displays is too large, very thick dielectrics are required to reach the low capacitance per unit area typical of capacitive touch sensors. Thus, the low dielectric constant permits the dielectrics in applied to a surface in a touch screen application to be only tens of microns thick. Such thin layers are easier to print than thick layers greater than 50 μm and have better overall optical properties.

When the transparent UV-curable dielectric ink is applied over the conductors formed by the exemplary conductive inks disclosed herein or the various transparent conductors such as those described in cited patent applications, the monomers in the wet ink do not attack the binder system used in the underlying conductors, and so does not degrade its conductivity, and further, may actually reduce the resistance by between 0% and 10%, for example and without limitation.

The resulting film thickness of the various representative uv-curable conductive and/or dielectric inks disclosed herein can be readily controlled from over 100 microns thick to well less than a micron thick while still being able to maintain, respectively, good conductivity and/or a good dielectric barrier. Generally, there are three methods for controlling the cured ink film thickness which can be used separately or in combination, any and all of which are within the scope of this disclosure, and may be utilized for both the conductive inks and the dielectric inks. In the first method, a screen mesh, if silk screen printing, or anilox roller, if flexographically printing, with the appropriate ink transfer properties can be selected to control the amount of ink deposited. In the second method, shrinkage in the range from 0.1 to 20% during uv curing can be adjusted by changing the concentration of cross-linking agent (e.g., difunctional monomer) in the ink. In the third method, the ink can be diluted with a solvent of moderate surface energy such as cyclohexanol. The various representative uv-curable conductive inks and transparent dielectric inks disclosed herein diluted with one or more solvents can be heated before curing to reduce the wet ink film volume before it is finally cured using uv. Very thin films are possible using this technique. For example, up to 50% cyclohexanol can be added to reduce the cured film thickness by more than 50% over the wet film thickness. Also for example, the exemplary or representative dielectric ink can also be diluted with 95% to 97% cyclohexanol to create thermal-uv cured dielectric films that are 5-10 μm thick when wet immediately after printing, but between 100 nm and 500 nm thick when fully cured by thermal and then uv exposure. While the various inks cure to an exceptionally low surface roughness, the addition of 5-30% cyclohexanol or other moderate surface energy solvents, the surface roughness is decreased even more, further improving cured film clarity, such as for a dielectric ink.

Low or no detectable odor is important with a functional ink. The various representative uv-curable conductive inks and transparent uv-curable dielectric inks described here have no discernable odor once cured, even when heated to 80° C. This prevents printed electronic devices that incorporate the transparent uv-curable dielectric ink from emitting any detectable odor at operating temperatures up to 90° C.

Additives may be included in the ink formulation to enhance resistance to environmentally induced damage, such as degradation from uv radiation or heat exposure. Ultraviolet protection of materials under the overcoats of the cured transparent uv-curable dielectric ink described in this application is very important in many applications, such as those using transparent conductors, some of which are sensitive to uv. The concentrations of these materials in the ink generally are kept to a minimum or low amount so as not to decrease transparency or cause other adverse effects upon the performance of the various representative transparent uv-curable dielectric inks disclosed herein.

In an exemplary embodiment, a representative transparent uv-curable dielectric ink was cured using a simultaneous uv exposure in four uv bands, to cure a 15 μm thick film of ink are as follows: in uv range from 395-445 nm total 1.159 joules with peak of 0.764 watts delivered, in uv range from 320-390 nm total 1.395 joules with peak of 0.959 watts delivered, in uv range from 280-320 nm total 2.414 joules with peak of 1.483 watts delivered, and in uv range from 250-260 nm total 2.455 joules with peak of 1.350 watts delivered.

The optically transmissive, dielectric film, trace or layer formed from the cured transparent uv-curable dielectric ink may be utilized in a wide variety of applications, namely, any application involving an insulating or dielectric layer, film or trace, for example and without limitation. Various applications are also illustrated in the cited patent applications. Numerous additional applications will be apparent to those having skill in the art.

Those having skill in the electronic or printing arts will recognize innumerable variations in the ways in which the conductive layers, films, wires or traces and/or optically transmissive, dielectric films, traces or layers may be formed using the conductive inks and/or dielectric inks of the present disclosure, with all such variations considered equivalent and within the scope of the disclosure. In addition, for various embodiments, the conductive layers, films, wires or traces and/or optically transmissive, dielectric films, traces or layers may be deposited as one or more single or continuous layers, such as through coating or printing, for example.

As may be apparent from the disclosure, exemplary conductive layers, films, wires or traces and/or optically transmissive, dielectric films, traces or layers, may be designed and fabricated to be highly flexible and deformable, potentially even foldable, stretchable and potentially wearable, rather than rigid. With such flexibility, exemplary conductive layers, films, wires or traces and/or optically transmissive, dielectric films, traces or layers may be rolled, such as a poster, or folded like a piece of paper, and fully functional when re-opened. Also for example, with such flexibility, exemplary conductive layers, films, wires or traces and/or optically transmissive, dielectric films, traces or layers may have many shapes and sizes, and be configured for any of a wide variety of styles and other aesthetic goals. Such exemplary conductive layers, films, wires or traces and/or optically transmissive, dielectric films, traces or layers are also considerably more resilient than prior art conductive layers, films, wires or traces and/or optically transmissive, dielectric films, traces or layers.

The common binding medium to produce the various representative uv-curable conductive inks and dielectric inks disclosed herein may be fabricated as discussed below. The alpha-hydroxyketone photoinitiator and alpha-aminoketone photoinitiator (or bis acyl phosphine photoinitiator) are mixed together in a 10% to 50% total concentration (in proportions as described above) until well dispersed or dissolved in the monofunctional acrylate monomer at room temperature to produce a photoinitiator formulation package. Processing the photoinitiators at room temperature helps to ensure shelf life stability of the completed ink until it is used on press. The stiff oligomer's viscosity is lowered by warming it to 40-50° C. and mixing it with between 10% to 50% of the monofunctional acrylate monomer to form the oligomer package. This lowers the viscosity of the oligomer from greater than 100,000 centipoise for the pure oligomer to between 1,000 and 20,000 centipoise for the diluted oligomer package in order to facilitate subsequent mixing with other ink formulation components at room temperature. The oligomer package is weighed after cooling to detect any monofunctional acrylate monomer loss from evaporation and additional monofunctional acrylate monomer is mixed in at room temperature to replace the amount lost to evaporation. The photoinitiator package, the oligomer package and additional monofunctional acrylate monomer are combined in appropriate ratios to produce the final formulation ratios desired for these components. The wetting, flow and leveling promotion agent and the cross-linking agent are added to the photoinitiator-monomer-oligomer mixture in appropriate ratios and mixed at room temperature to produce the complete common binding medium, such as for direct use as the transparent uv dielectric ink formulation, or for use in the various conductive inks. Finally, if needed for the application, the uv absorber and rheological additives can be mixed in at room temperature until fully dispersed.

For the various exemplary or representative conductive ink compositions, the conductive particles, flakes, wires or threads are milled or sonicated into the oligomer package. Then the photo initiator package, the oligomer package with the conductive particles, and any additional monofunctional acrylate monomer are combined, followed by the addition of any graphene (also milled or sonicated), all in appropriate ratios to produce the final formulation ratios (percentages) desired for these components for the exemplary or representative conductive ink compositions.

Although the invention has been described with respect to specific embodiments thereof, these embodiments are merely illustrative and not restrictive of the invention. In the description herein, numerous specific details are provided, such as examples of electronic components, electronic and structural connections, materials, and structural variations, to provide a thorough understanding of embodiments of the present invention. One skilled in the relevant art will recognize, however, that an embodiment of the invention can be practiced without one or more of the specific details, or with other apparatus, systems, assemblies, components, materials, parts, etc. In other instances, well-known structures, materials, or operations are not specifically shown or described in detail to avoid obscuring aspects of embodiments of the present invention. One having skill in the art will further recognize that additional or equivalent method steps may be utilized, or may be combined with other steps, or may be performed in different orders, any and all of which are within the scope of the claimed invention. In addition, the various Figures are not drawn to scale and should not be regarded as limiting.

Reference throughout this specification to “one embodiment”, “an embodiment”, or a specific “embodiment” means that a particular feature, structure, or characteristic described in connection with the embodiment is included in at least one embodiment and not necessarily in all embodiments, and further, are not necessarily referring to the same embodiment. Furthermore, the particular features, structures, or characteristics of any specific embodiment may be combined in any suitable manner and in any suitable combination with one or more other embodiments, including the use of selected features without corresponding use of other features. In addition, many modifications may be made to adapt a particular application, situation or material to the essential scope and spirit of the present invention. It is to be understood that other variations and modifications of the embodiments of the present invention described and illustrated herein are possible in light of the teachings herein and are to be considered part of the spirit and scope of the present invention.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

All documents cited in the Detailed Description are, in relevant part, incorporated herein by reference; the citation of any document is not to be construed as an admission that it is prior art with respect to the present invention. To the extent that any meaning or definition of a term in this document conflicts with any meaning or definition of the same term in a document incorporated by reference, the meaning or definition assigned to that term in this document shall govern.

Combinations of components of steps will also be considered within the scope of the present invention, particularly where the ability to separate or combine is unclear or foreseeable. The disjunctive term “or”, as used herein and throughout the claims that follow, is generally intended to mean “and/or”, having both conjunctive and disjunctive meanings (and is not confined to an “exclusive or” meaning), unless otherwise indicated. As used in the description herein and throughout the claims that follow, “a”, “an”, and “the” include plural references unless the context clearly dictates otherwise. Also as used in the description herein and throughout the claims that follow, the meaning of “in” includes “in” and “on” unless the context clearly dictates otherwise.

The foregoing description of illustrated embodiments of the present invention, including what is described in the summary or in the abstract, is not intended to be exhaustive or to limit the invention to the precise forms disclosed herein. From the foregoing, it will be observed that numerous variations, modifications and substitutions are intended and may be effected without departing from the spirit and scope of the novel concept of the invention. It is to be understood that no limitation with respect to the specific methods and apparatus illustrated herein is intended or should be inferred. It is, of course, intended to cover by the appended claims all such modifications as fall within the scope of the claims.

It is claimed:

1. A composition for an ultraviolet-curable conductive ink, the composition comprising:
a plurality of conductive particles;
a difunctional aliphatic polycarbonate urethane acrylate oligomer;
a monofunctional acrylate monomer selected from the group consisting of: an isophoryl acrylate monomer, an acrylate ester monomer, a 3,3,5 trimethyl cyclohexanol acrylate monomer, and mixtures thereof;
a difunctional acrylate monomer selected from the group consisting of: a difunctional alkoxylated acrylate monomer, a difunctional methacrylate monomer, an alkoxylated hexandiol acrylate monomer, a 1,6-hexandiol diacrylate monomer, and mixtures thereof;
a first photoinitiator comprising an α-hydroxyketone class photoinitiator;
a second photoiniator different from the first photoinitiator and comprising an α-aminoketone class photoinitiator; and
a wetting, flow and/or leveling promoter comprising one or more copolymers of ethyl acrylate and 2-ethylhexyl acrylate.

2. The composition of claim 1, wherein the plurality of conductive particles comprise at least one conductor selected from the group consisting of: aluminum, copper, silver, gold, nickel, palladium, tin, platinum, lead, zinc, graphene, alloys thereof, and mixtures thereof.

3. The composition of claim 1, wherein the plurality of conductive particles comprise a mixture of graphene particles, and either or both silver particles or silver coated copper particles.

4. The composition of claim 1, wherein:
the plurality of conductive particles are present in an amount between about 77.5% to 82.5% by weight and comprise silver particles and graphene particles;
the difunctional aliphatic polycarbonate urethane acrylate oligomer is present in an amount between about 9.5% to 10.5% by weight;
the monofunctional acrylate monomer is present in an amount between about 5.5% to 6.5% by weight;
the difunctional acrylate monomer is present in an amount between about 0.6% to 1.2% by weight;
the first photoinitiator is present in an amount between about 1.8% to 2.2% by weight;
the second photoiniator is present in an amount between about 0.8% to 1.2% by weight; and
the wetting, flow and/or leveling promoter is present in an amount between about 0.14% to 0.3% by weight.

5. The composition of claim 4, wherein the graphene particles are present in an amount between about 0.20% to 0.30% by weight.

6. The composition of claim 4, wherein the graphene particles are present in an amount of about 0.25% by weight and the silver particles are present in an amount of about 79.75% by weight.

7. A method of manufacturing the composition of claim 4, comprising:
mixing the first and second photoinitiators with the monofunctional acrylate monomer to form a photoinitiator monofunctional acrylate monomer mixture;
mixing the difunctional aliphatic polycarbonate urethane acrylate oligomer and the monofunctional acrylate monomer to form an oligomer and monomer mixture;
mixing the photoinitiator monofunctional acrylate monomer mixture with the oligomer and monomer mixture;
adjusting any weight percentages of the monofunctional acrylate monomer and difunctional aliphatic polycarbonate urethane acrylate oligomer;
adding and mixing the difunctional acrylate monomer and the wetting, flow and/or leveling promoter or promotion agent;
adding and mixing the silver particles; and
adding and mixing the graphene particles.

8. A conductive layer, film or trace formed from ultraviolet and thermal curing of the composition of claim 4.

9. The composition of claim 1, further comprising at least one solvent selected from the group consisting of: water; alcohols; cyclic alcohols; lactones; cyclic ketones; glycols; glycerols; carboxylic acids; dicarboxylic acids; tricarboxylic acids; alkyl carboxylic acids; benzene derivatives; butane derivatives; and mixtures thereof.

10. The composition of claim 1, further comprising a viscosity or rheology modifier selected from the group consisting of: acrylate and (meth)acrylate polymers, copolymers, polymeric precursors or polymerizable precurors; fumed silica, silica powders; and mixtures thereof.

11. A composition for an ultraviolet-curable conductive ink, the composition comprising:
a plurality of conductive particles;
a difunctional aliphatic polycarbonate urethane acrylate oligomer;
a monofunctional monomer selected from the group consisting of: urethane monomers, acrylate monomers, epoxy monomers, vinyl monomers, vinyl-ether monomers, polyester monomers, and mixtures thereof;
a difunctional or trifunctional monomer selected from the group consisting of: urethane monomers, acrylate monomers, epoxy monomers, vinyl monomers, vinyl-ether monomers, polyester monomers, and mixtures thereof;
a first photoinitiator; and
a second photoiniator different from the first photoinitiator.

12. The composition of claim 11, wherein the monofunctional monomer is a monofunctional acrylate monomer.

13. The composition of claim 11, wherein the monofunctional monomer is selected from the group consisting of: an isophoryl acrylate monomer, an acrylate ester monomer, a 3,3,5 trimethyl cyclohexanol acrylate monomer, vinyl pyrollidone, vinyl caprolactam, and mixtures thereof.

14. The composition of claim 11, wherein the difunctional or trifunctional monomer is a difunctional acrylate monomer.

15. The composition of claim 11, wherein the difunctional or trifunctional monomer is selected from the group consisting of: a difunctional alkoxylated acrylate monomer, a difunctional methacrylate monomer, an alkoxylated hexandiol acrylate monomer, a 1,6-hexandiol diacrylate monomer, and mixtures thereof.

16. The composition of claim 11, further comprising:
a wetting, flow and/or leveling promoter or promotion agent.

17. The composition of claim 16, wherein the wetting, flow and/or leveling promoter or promotion agent is an acrylate copolymer.

18. The composition of claim 16, wherein the wetting, flow and/or leveling promoter or promotion agent is one or more copolymers of ethyl acrylate and 2-ethylhexyl acrylate.

19. The composition of claim 11, further comprising a thermal initiator, and wherein the first photoinitiator, the second photoiniator and the thermal initiator are selected from the group consisting of: 1,1-bis(tert-butylperoxy)-3,3,5-trimethylcyclohexane, 1,1′-azobis(cyclohexanecarbonitrile), benzoyl peroxide, tert-butyl peroxy-2 ethylhexanoate, 1,1-Di(tert-butylperoxy)-3,3,5-trimethylcyclohexane, α-hydroxyketones, phenylglyoxylates, benzyldimethyl-ketals, α-aminoketones, mono acyl phosphines, bis acyl phosphines, phosphine oxides, metallocenes, iodonium salts, and mixtures thereof.

20. The composition of claim 11, wherein the first photoinitiator is an α-hydroxyketone class photoinitiator and the second photoinitiator is an α-aminoketone class photoinitiator.

21. The composition of claim 11, wherein the plurality of conductive particles comprise at least one conductor selected from the group consisting of: aluminum, copper, silver, gold, nickel, palladium, tin, platinum, lead, zinc, graphene, alloys thereof, and mixtures thereof.

22. The composition of claim 11, wherein the plurality of conductive particles comprise a mixture of graphene particles and either or both silver particles or silver coated copper particles.

23. The composition of claim 11, further comprising:
a wetting, flow and/or leveling promoter or promotion agent present in an amount in the binding medium between about 0.14% to 0.3% by weight and comprising a polymer or copolymer of ethyl acrylate or 2-ethylhexyl acrylate;
wherein:
the plurality of conductive particles are present in an amount between about 77.5% to 82.5% by weight and comprise silver particles and graphene particles;
the difunctional aliphatic polycarbonate urethane acrylate oligomer is present in an amount between about 9.5% to 10.5% by weight;
the monofunctional monomer is present in an amount between about 5.5% to 6.5% by weight and comprises a monofunctional acrylate monomer selected from the group consisting of: an isophoryl acrylate monomer, an acrylate ester monomer, a 3,3,5 trimethyl cyclohexanol acrylate monomer, and mixtures thereof;
the difunctional or trifunctional monomer is present in an amount between about 0.6% to 1.2% by weight and comprises a difunctional acrylate monomer selected from the group consisting of: a difunctional alkoxylated acrylate monomer, a difunctional methacrylate monomer, an alkoxylated hexandiol acrylate monomer, a 1,6-hexandiol diacrylate monomer, and mixtures thereof;
the first photoinitiator is present in an amount between about 1.8% to 2.2% by weight and comprises an α-hydroxyketone class photoinitiator; and
the second photoiniator is present in an amount between about 0.8% to 1.2% by weight and comprises an α-aminoketone class photoinitiator.

24. The composition of claim 23, wherein the graphene particles are present in an amount between about 0.20% to 0.30% by weight.

25. A composition for an ultraviolet-curable conductive ink, the composition comprising:
a plurality of conductive particles present in an amount between about 77.5% to 82.5% by weight and comprising silver particles and graphene particles;
a difunctional aliphatic polycarbonate urethane acrylate oligomer present in an amount between about 9.5% to 10.5% by weight;
a monofunctional acrylate monomer present in an amount between about 5.5% to 6.5% by weight and selected from the group consisting of: an isophoryl acrylate monomer, an acrylate ester monomer, a 3,3,5 trimethyl cyclohexanol acrylate monomer, and mixtures thereof;
a difunctional acrylate monomer present in an amount between about 0.6% to 1.2% by weight and selected from the group consisting of: a difunctional alkoxylated acrylate monomer, a difunctional methacrylate monomer, an alkoxylated hexandiol acrylate monomer, a 1,6-hexandiol diacrylate monomer, and mixtures thereof;
a first photoinitiator present in an amount between about 1.8% to 2.2% by weight and comprising an α-hydroxyketone class photoinitiator;
a second photoiniator different from the first photoinitiator, the second photoiniator present in an amount between about 0.8% to 1.2% by weight and comprising an α-aminoketone class photoinitiator; and
one or more copolymers of ethyl acrylate and 2-ethylhexyl acrylate present in an amount between about 0.14% to 0.3% by weight.
